(19) United States
(12) Patent Application Publication
(10) Pub. No.: US 2026/0121539 A1
(43) Pub. Date: Apr. 30, 2026

(54) HYBRID VOLTAGE REGULATOR

(71) Applicant: Advanced Micro Devices, Inc., Santa Clara, CA (US)

(72) Inventor: Shiguo Luo, Austin, TX (US)

(73) Assignee: Advanced Micro Devices, Inc., Santa Clara, CA (US)

(21) Appl. No.: 18/925,885

(22) Filed: Oct. 24, 2024

(51) Int. Cl. H02M 3/158; H02M 1/14

(52) U.S. Cl. CPC H02M 3/1586; H02M 1/14

(57) ABSTRACT

A hybrid voltage regulator device can include a hybrid phase circuit and a capacitor. The hybrid phase circuit can include a heterogeneous power stage and a nonlinear inductor coupled between the heterogeneous power stage and the capacitor. The heterogeneous power stage can be configured to provide a signal to the nonlinear inductor. The hybrid phase circuit can be configured to selectively operate in a first mode, wherein an amplitude of a current of the signal is less than a first threshold amplitude and a first inductance of the nonlinear inductive component is greater than a first threshold inductance. The hybrid phase circuit also can be configured to selectively operate in a second mode, wherein the amplitude of the current of the signal is greater than a second threshold amplitude, and a second inductance of the nonlinear inductive component is less than a second threshold inductance.

### BACKGROUND

Voltage regulator (VR) devices regulate the voltage of an electrical signal (e.g., power supply signal). Switched mode voltage regulator devices (“switching regulators” or “switched mode regulators”) regulate the power supply voltage by switching one or more switches (e.g., transistors) on and off, with the duty cycles of the switches determining how much charge is transferred from the power supply to the load. Switching regulators can be highly efficient and are often used in computer systems. A VR having many phase circuits (PCs) may be referred to as multi-phase VR. Many multi-phase VRs are high-power devices (e.g., they regulate voltages at output nodes that deliver currents with high amplitudes).

### BRIEF DESCRIPTION OF THE FIGURES

The accompanying drawings illustrate a number of example implementations and are a part of the specification. Together with the following description, these drawings demonstrate and explain various principles of the present disclosure.

FIG. 1 is a block diagram of an example computer system with supply voltages of one or more components regulated by an example voltage regulator.

FIG. 2 is a block diagram of an example of a multi-phase voltage regulator.

FIG. 3A is a block diagram of an example of a hybrid voltage regulator.

FIG. 3B is an example of an inductance-current (L-I) curve of a linear inductor.

FIG. 3C is an example of an inductance-current (L-I) curve of a nonlinear inductor.

FIG. 4A shows a schematic of an example homogeneous power stage (Pstage) of a phase circuit of a voltage regulator.

FIG. 4B shows a schematic of an example heterogeneous power stage of a hybrid phase circuit of a hybrid voltage regulator.

FIG. 4C shows a schematic of another example heterogeneous power stage of a hybrid phase circuit of a hybrid voltage regulator.

FIG. 5 is a flow diagram of an example method for regulating a voltage of a power supply signal.

FIG. 6A is a flow diagram of another example method for regulating a voltage of a power supply signal.

FIG. 6B is a state transition diagram of another example method for regulating a voltage of a power supply signal.

FIG. 7A is a timing diagram of phase currents of an example multiphase configuration of a hybrid voltage regulator.

FIG. 7B is a timing diagram of a load current of an example hybrid voltage regulator, when configured to produce the phase currents of FIG. 7A.

FIG. 7C is a timing diagram of phase currents of another example multiphase configuration of a hybrid voltage regulator.

FIG. 7D is a timing diagram of a load current of a hybrid voltage regulator, when configured to produce the phase currents of FIG. 7C.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure describes a hybrid voltage regulator having a heterogeneous power stage and one or more nonlinear inductors. In some examples, such a hybrid voltage regulator exhibits high power efficiency in the light- to medium-load range, while maintaining good transient performance (e.g., rapid response to transient spikes in demand for load current).

The power efficiency of a computer system's voltage regulator has a significant impact on the system's overall power efficiency. For mobile computing devices (e.g., laptop computers, tablets, smartphones, smartwatches, implantable health monitoring devices, wearable computers, personal digital assistants, etc.), high power-efficiency in low-power operating modes can be critical to the device's overall battery performance, because many mobile devices operate with very-low-power loads (or “light loads”) more than 70% of the time. For some other computing devices (e.g., the high-performance processors used for graphics workloads or AI workloads), battery performance or power efficiency for very-low-power loads may be less important, but any improvement in power efficiency can substantially reduce operating costs (e.g., the cost of the energy used to process a workload and/or operate the computer system).

In many computer systems, the phase circuits of voltage regulators have power stages (e.g., switching circuits) that control the amount of power (or current) delivered from the system's power supply to the system's load (e.g., a processing device or other integrated circuit). A power stage can include one or more high-side switches, one or more low-side switches, and a driver circuit that controls the delivery of power to the load by controlling the duty cycles of the switches. When the voltage regulator operates with a high-power load (or “heavy load”), the high-side switches may remain in a conducting state for relatively long periods of time, such that current is continually delivered from the power supply to the load with little or no switching. However, when the voltage regulator operates with a very-low-power load, the high-side switches may operate on very short duty cycles, such that the switches operate in a conducting state for a brief period, during which current is delivered from the power supply to the voltage regulator's filter, and then the switches rapidly transition back to a non-conducting state. The switching losses associated with rapidly toggling the switches between conducting and non-conducting states can be significant, yielding poor power efficiency for very-low-power loads. (Phase circuits that are configured to provide low currents in this manner may be referred to herein as “full-power phase circuits.”)

One technique for increasing the power efficiency of a voltage regulator (VR) for very-low-power loads is to equip the VR with a phase circuit configured to provide very low currents (e.g., load currents of 3 A or less) with low-frequency switching, yielding low switching losses. Such a phase circuit is sometimes referred to as a “baby phase circuit” or “baby phase.” Such a “baby phase circuit” can include a small number of switches (e.g., metal-oxide semiconductor field-effect transistors or “MOSFETs”) and an inductor with relatively high inductance (e.g., a few hundred nH). As such, the baby phase circuit can operate at a relatively low switching frequency with reduced switching loss and inductor core loss, yielding higher light-load efficiency than a typical full-power phase circuit. Furthermore, a lower input voltage can be applied to the circuitry of the baby phase circuit, which can further reduce switching loss and increase light-load efficiency.

However, adding a baby phase circuit to a voltage regulator (VR) can adversely affect the VR's cost and the compatibility of the VR's components (e.g., VR controller, VR device) with the components of other VRs. A VR controller package generally uses three pins to control each phase circuit of a VR device. When pins on the controller package are dedicated to controlling a baby phase circuit, those pins are unavailable to control a full-power phase circuit. Thus, adding baby phase circuits to a voltage regulator decreases the number of full-power phase circuits that the VR controller can drive, which ultimately reduces the maximum current the voltage regulator can supply to a load. Increasing the VR controller's pin count to accommodate the baby phase circuits can significantly increase the per-unit cost of the VR controller.

Furthermore, irrespective of whether pins are added to the VR controller to drive one or more baby phase circuits, the driver circuits in existing VR controllers are often not capable of safely driving a baby phase circuit. The transistors of full-power phase circuits generally operate at high voltages and conduct large currents, while the transistors of baby phase circuits generally operate at lower voltages and conduct smaller currents. Thus, the preferred driver circuits for baby phase circuits and full-power phase circuits may be fabricated using different semiconductor fabrication processes suited to low-power transistors and high-power transistors, respectively. Integrating driver circuits fabricated using different semiconductor fabrication processes into the same VR controller can significantly increase both the cost and complexity of the VR controller.

In addition, adding a baby phase circuit to a VR can degrade aspects of the VR's performance (e.g., by increasing the amplitude of the ripple in the VR's load current, reducing the maximum current deliverable by the VR in heavy-load mode, and slowing the VR's response to transient fluctuations in load). Thus, there is a need for a voltage regulator that provides increased power efficiency for light loads, without unduly increasing the VR's cost and without significantly degrading the VR's performance characteristics. In addition, there is a need for a VR that provides such benefits using components (e.g., VR controller, VR device) that are compatible with the components of other voltage regulators.

Disclosed herein is a hybrid voltage regulator (HVR) including at least one hybrid phase circuit. A hybrid phase circuit can include a heterogeneous power stage and a nonlinear inductive component (e.g., nonlinear inductor). The heterogeneous power stage can include switch control and driver circuitry, one or more high-side switches, and one or more low-side switches. When operating in very-low-power mode, the driving circuitry operates a subset of the heterogeneous power stage's transistors at a relatively low frequency and deactivates the remaining transistors. Thus, in the low-power mode, the heterogeneous power stage provides a relatively small amount of current (e.g., less than 3 A) to the hybrid phase circuit's nonlinear inductive component, which (in response to the small amount of current) exhibits a relatively high inductance (e.g., 470 nH). In contrast, when operating in full-power mode, the driving circuitry operates a stronger subset of the heterogeneous power stage's transistors at a frequency suitable for supplying a relatively large amount of current (e.g., up to 35 A). Thus, in the full-power mode, the hybrid phase circuit provides a relatively large amount of current to the nonlinear inductor, which (in response to the large amount of current) exhibits a relatively low inductance (e.g., 100 nH) after passing a saturation threshold (e.g., its first preset saturation threshold). In this way, the hybrid phase circuit exhibits high power efficiency in the very-low-power mode, and is capable of providing large currents in full-power mode.

The HVR's use of at least one hybrid phase circuit addresses many of the shortcomings associated with the use of dedicated “baby phases.” The hybrid phase circuit functions multi-modally as a very-low-power phase circuit or a full-power phase circuit, so the pins used by the VR controller to drive the hybrid phase circuit are not dedicated to driving a low-power phase circuit. Thus, replacing a full-power phase circuit of a voltage regulator with a hybrid phase circuit does not necessarily decrease the maximum current the voltage regulator can supply to a load, and does not necessitate the addition of more pins to the VR controller. Furthermore, for reasons described in further detail below, the hybrid phase circuit can be implemented such that the VR controller can use the same number of pins to drive the heterogeneous power stage of a hybrid phase circuit and the homogeneous power stages of other phase circuits. Thus, replacing a full-power phase circuit of a voltage regulator with a hybrid phase circuit need not unduly increase the manufacturing cost or complexity of the VR controller, and VR controllers suitable for controlling the HVR can also be used to control conventional voltage regulators that have no hybrid phase circuits. In short, the HVR facilitates standardization of VR controllers.

In some examples, the HVR includes at least one hybrid phase circuit (which can include at least one heterogeneous power stage) and at least one nonlinear phase circuit (e.g., a phase circuit with a nonlinear inductive component). In some examples, such configurations of the HVR can exhibit high efficiency operation not only for very-low-power loads (e.g., loads of 3 A or less), but also for low-power loads (e.g., loads of 3-8 A). In this way, the HVR can exhibit high efficiency operation for the loads processed by some mobile devices more than 90% of the time. In some examples, the HVR further includes at least one linear phase circuit (e.g., a phase circuit with a linear inductive component). In some examples, such configurations of the HVR can use the linear phase circuit(s) to respond quickly to sudden increases in demand for load current (e.g., transient spikes in load current).

When operating a multiphase voltage regulator having M parallel phase circuits producing a supply signal in M phases, one approach is to uniformly interleave the phases of the signals provided by the M phase circuits such that the phase separation between adjacent signals is approximately M/360 degrees. The purpose of such interleaving is to evenly distribute the pulses of current provided by the parallel phase circuits, such that the ripple in the load current produced by combining the current pulses is reduced. However, with the HVR, the amplitudes of the current pulses produced by the hybrid phase circuit and the nonlinear phase circuit(s) in some scenarios can be substantially smaller than the amplitudes of the current pulses produced by the linear phase circuit(s). Thus, uniformly interleaving the current pulses provided by the phase circuits of the HVR can yield increased ripple in the magnitude of the load current, relative to load currents produced by other voltage regulators.

Disclosed herein is an improved method for controlling a hybrid voltage regulator (HVR). In some examples, the HVR uniformly interleaves the phases of the signals provided in parallel by (1) any hybrid phase circuits operating in full-power mode, (2) any nonlinear phase circuits operating in full-power mode (e.g., the nonlinear inductive components of these nonlinear phase circuits are operating in a region of low inductance), and (3) the linear phase circuits. In addition, the HVR uniformly interleaves the phases of the signals provided in parallel by (1) any hybrid phase circuits providing very-low or low load current, and (2) any nonlinear phase circuits providing low load current (e.g., the nonlinear inductive components of these hybrid and/or nonlinear phase circuits are operating in a region of high inductance). In some examples, this method for controlling the HVR can reduce the magnitude of the ripple in the load current by more than 50% relative to uniformly interleaving the phases of all the signals provided by the HVR's phase circuits in parallel.

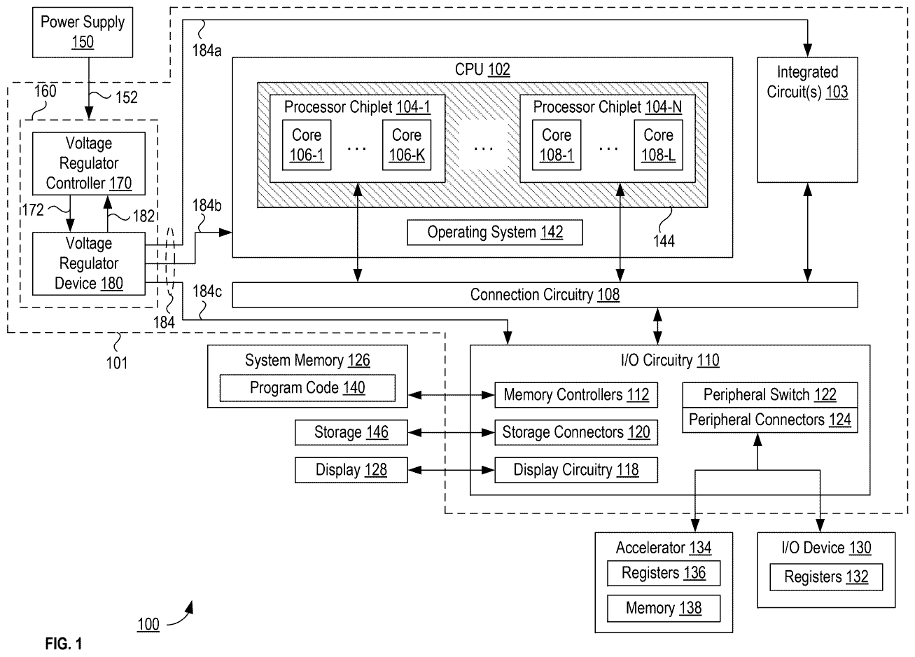

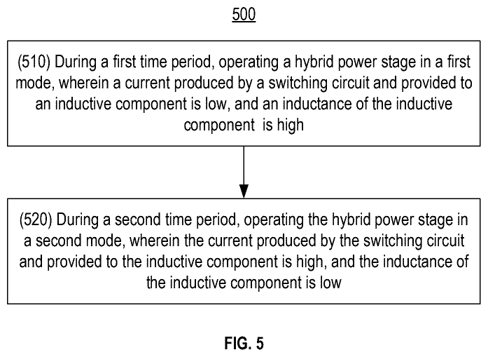

This disclosure provides, with reference to FIGS. 1-4, detailed descriptions of example voltage regulator devices and systems. Detailed descriptions of corresponding voltage regulator methods are provided in connection with FIGS. 5-7.

In some aspects, the techniques described herein relate to a computer system including: one or more integrated circuits; and a voltage regulator device including a hybrid phase circuit and a capacitive component, wherein the hybrid phase circuit includes a heterogeneous power stage and a nonlinear inductive component coupled between the hybrid phase circuit and the capacitive component, and the heterogeneous power stage is configured to provide a signal to the nonlinear inductive component, wherein the hybrid phase circuit is configured to selectively operate in a first mode, wherein an amplitude of a current of the signal is less than a first threshold amplitude and a first inductance of the nonlinear inductive component is greater than a first threshold inductance, wherein the hybrid phase circuit is further configured to selectively operate in a second mode, wherein the amplitude of the current of the signal is greater than a second threshold amplitude, and a second inductance of the nonlinear inductive component is less than a second threshold inductance, and wherein the voltage regulator device is configured to provide a power supply signal having a regulated voltage to the one or more integrated circuits.

In some aspects, the techniques described herein relate to a computer system, further including a voltage regulator (VR) controller coupled to the voltage regulator device and configured to control an amplitude of the regulated voltage of the power supply signal provided by the voltage regulator device.

In some aspects, the techniques described herein relate to a computer system, wherein the VR controller is further configured to control the hybrid phase circuit to operate in the first mode during a first time period based on the amplitude of the current of the signal being less than the first threshold amplitude during the first time period, and to control the hybrid phase circuit to operate in the second mode during a second time period based on the amplitude of the current of the signal being greater than the second threshold amplitude during the second time period.

In some aspects, the techniques described herein relate to a computer system, wherein: the VR controller controlling the hybrid phase circuit to operate in the first mode during the first time period includes the VR controller providing a first plurality of control signals to heterogeneous power stage during the first time period, and the VR controller controlling the hybrid phase circuit to operate in the second mode during the second time period includes the VR controller providing a second plurality of control signals to the heterogeneous power stage during the second time period.

In some aspects, the techniques described herein relate to a computer system, wherein the hybrid phase circuit is a first phase circuit, the heterogeneous power stage is a first power stage, the nonlinear inductive component is a first nonlinear inductive component, and the signal provided by the first phase circuit is a first signal, and the voltage regulator device further includes: one or more second phase circuits, each of the second phase circuits including a second nonlinear inductive component and a second power stage configured to provide a second signal to the second nonlinear inductive component, wherein the second nonlinear inductive component of each second phase circuit is coupled between the second power stage of the respective second phase circuit and the capacitive component; one or more third phase circuits, each of the third phase circuits including a third inductive component and a third power stage configured to provide a third signal to the third inductive component, wherein the third inductive component of each third phase circuit is coupled between the third power stage of the respective third phase circuit and the capacitive component;

In some aspects, the techniques described herein relate to a computer system, wherein the VR controller is further configured to perform operations including: monitoring one or more parameters of the voltage regulator device; and controlling an operating mode of the voltage regulator device based on whether the one or more monitored parameters satisfy one or more criteria.

In some aspects, the techniques described herein relate to a computer system, wherein the one or more parameters of the voltage regulator device include an amplitude of a current of the power supply signal provided by the voltage regulator device to the one or more integrated circuits.

In some aspects, the techniques described herein relate to a computer system, wherein the one or more criteria relate to respective relationships between the amplitude of the current of the power supply signal and one or more threshold amplitudes or ranges.

In some aspects, the techniques described herein relate to a computer system, wherein controlling the operating mode of the voltage regulator device based on whether the one or more monitored parameters satisfy one or more criteria includes: based on the monitored one or more parameters satisfying a first subset of the one or more criteria, controlling the voltage regulator device to operate in a first mode, wherein, in the first mode, the first phase circuit, the one or more second phase circuits, and the one or more third phase circuits of the voltage regulator device are activated, and a switching frequency of a plurality of transistors of the first phase circuit, the one or more second phase circuits, and the one or more third phase circuits exceeds a first frequency threshold.

In some aspects, the techniques described herein relate to a computer system, wherein, in the first mode: the first signal provided to the first nonlinear inductive component and the one or more second signals provided to the one or more second nonlinear inductive components are interleaved with a phase separation of approximately (1+S2)/360 degrees, where S2 is the number of second phase circuits; and the one or more third signals provided to the one or more third inductive components are interleaved with a phase separation of approximately S3/360 degrees, where S3 is the number of third phase circuits.

In some aspects, the techniques described herein relate to a computer system, wherein controlling the operating mode of the voltage regulator device based on whether the one or more monitored parameters satisfy one or more criteria includes: based on the monitored one or more parameters satisfying a second subset of the one or more criteria, controlling the voltage regulator device to operate in a second mode, wherein, in the second mode, the first phase circuit and the one or more second phase circuits of the voltage regulator device are activated, the one or more third phase circuits of the voltage regulator device are deactivated, and a switching frequency of a plurality of transistors of the first phase circuit and the one or more second phase circuits is less than the first frequency threshold and greater than a second frequency threshold.

In some aspects, the techniques described herein relate to a computer system, wherein, in the second mode: the first signal provided to the first nonlinear inductive component and the one or more second signals provided to the one or more second nonlinear inductive components are interleaved with a phase separation of approximately (1+S2)/360 degrees, where S2 is the number of the one or more second phase circuits.

In some aspects, the techniques described herein relate to a computer system, wherein controlling the operating mode of the voltage regulator device based on whether the one or more monitored parameters satisfy one or more criteria includes: based on the monitored one or more parameters satisfying a third subset of the one or more criteria, controlling the voltage regulator device to operate in a third mode, wherein, in the third mode, the first phase circuit of the voltage regulator device is activated, the one or more second phase circuits and the one or more third phase circuits of the voltage regulator device are deactivated, a switching frequency of a plurality of transistors of the first phase circuit is less than the second frequency threshold, and the first phase circuit operates in the second mode.

In some aspects, the techniques described herein relate to a computer system, wherein controlling the operating mode of the voltage regulator device based on whether the one or more monitored parameters satisfy one or more criteria includes: based on the monitored one or more parameters satisfying a fourth subset of the one or more criteria, controlling the voltage regulator device to operate in a fourth mode, wherein, in the fourth mode, the first phase circuit of the voltage regulator device is activated, the one or more second phase circuits and the one or more third phase circuits of the voltage regulator device are deactivated, a switching frequency of a plurality of transistors of the first phase circuit is less than a third frequency threshold, and the first phase circuit operates in the first mode.

In some aspects, the techniques described herein relate to a computer system, further including a printed circuit board, wherein the voltage regulator device and the one or more integrated circuits are attached to the printed circuit board, and wherein the voltage regulator device is electrically coupled to the one or more integrated circuits via the printed circuit board.

In some aspects, the techniques described herein relate to a computer system, wherein the one or more integrated circuits include a central processing unit (CPU), a graphics processing unit (GPU), and/or an accelerated processing unit (APU).

In some aspects, the techniques described herein relate to a voltage regulator device including: a hybrid phase circuit including a heterogeneous power stage and a nonlinear inductive component; and a capacitive component, wherein a first terminal of the nonlinear inductive component is coupled to an output terminal of the heterogeneous power stage, a second terminal of the nonlinear inductive component is coupled to a terminal of the capacitive component, and the heterogeneous power stage is configured to provide a signal to the nonlinear inductive component, wherein the hybrid phase circuit is configured to selectively operate in a first mode, wherein an amplitude of a current of the signal is less than a first threshold amplitude and a first inductance of the nonlinear inductive component is greater than a first threshold inductance, and wherein the hybrid phase circuit is further configured to selectively operate in a second mode, wherein the amplitude of the current of the signal is greater than a second threshold amplitude, and a second inductance of the nonlinear inductive component is less than a second threshold inductance.

In some aspects, the techniques described herein relate to a voltage regulator device, wherein the hybrid phase circuit and the capacitive component form a DC-to-DC converter.

In some aspects, the techniques described herein relate to a voltage regulator device, wherein the heterogeneous power stage includes switch control and driver circuitry and a plurality of half bridges.

In some aspects, the techniques described herein relate to a voltage regulator device, wherein: in the first mode, a first number N1 of the half bridges are configured to provide the signal to the nonlinear inductive device, in the second mode, a second number N2 of the half bridges are configured to provide the signal to the nonlinear inductive device, and 1<N1<N2.

In some aspects, the techniques described herein relate to a voltage regulator device, wherein: in the first mode, a first set S1 of the half bridges are configured to provide the signal to the nonlinear inductive device, in the second mode, a second set S2 of the half bridges are configured to provide the signal to the nonlinear inductive device, and the first and second sets are disjoint.

In some aspects, the techniques described herein relate to a voltage regulator device, wherein: in the first mode, when one or more first switches of the heterogeneous power stage operate with a first duty cycle, the amplitude of the current of the signal has a first value, and in the second mode, when one or more second switches of the heterogeneous power stage operate with the first duty cycle, the amplitude of the current of the signal has a second value greater than the first value.

In some aspects, the techniques described herein relate to a voltage regulator device, wherein the hybrid phase circuit is a first phase circuit, the heterogeneous power stage is a first power stage, and the nonlinear inductive component is a first nonlinear inductive component, the voltage regulator device further including: one or more second phase circuits, each of the second phase circuits including a second power stage and a second nonlinear inductive component coupled between the respective second power stage and the capacitive component.

In some aspects, the techniques described herein relate to a voltage regulator device, further including: one or more third phase circuits, each of the third phase circuits including a third power stage and a third inductive component coupled between the respective third power stage and the capacitive component.

In some aspects, the techniques described herein relate to a method including: producing, by a heterogeneous power stage of a voltage regulator device, a signal; and providing the signal to a nonlinear inductive component coupled between the heterogeneous power stage and a capacitive component of the voltage regulator device, wherein producing the signal includes during a first time period, operating the heterogeneous power stage in a first mode, wherein an amplitude of a current of the signal is less than a first threshold amplitude and a first inductance of the nonlinear inductive component is greater than a first threshold inductance, and during a second time period, operating the heterogeneous power stage in a second mode, wherein the amplitude of the current of the signal is greater than a second threshold amplitude, and a second inductance of the nonlinear inductive component is less than a second threshold inductance.

In some aspects, the techniques described herein relate to a method, wherein: the heterogeneous power stage includes a plurality of half bridges, operating the heterogeneous power stage in the first mode includes activating at least one and at most N1 of the half bridges and deactivating one or more of the half bridges, operating the heterogeneous power stage in the second mode includes activating at least N2 of the half bridges, and 1<N1<N2.

In some aspects, the techniques described herein relate to a method, wherein: the heterogeneous power stage includes a plurality of half bridges, operating the heterogeneous power stage in the first mode includes activating a first non-empty set of the half bridges and deactivating a second non-empty set of the half bridges, and operating the heterogeneous power stage in the second mode includes deactivating the first non-empty set of the half bridges and activating the second non-empty set of the half bridges.

FIG. 1 illustrates one exemplary implementation of a computer system 100 configured to implement the techniques described herein, although others are possible. It should be appreciated that FIG. 1 is intended neither to be a depiction of necessary components for a computer system 100 to operate in accordance with the principles described herein, nor a comprehensive depiction.

Computer system 100 can be, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. Computer system 100 can comprise at least one central processing unit (CPU) 102, one or more integrated circuits 103 (e.g., graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), other processing device, other integrated circuit etc.), connection circuitry 108, I/O circuitry 110, system memory 126, at least one I/O device 130, at least one accelerator 134, storage 146 (e.g., computer-readable storage media), and/or at least one display 128. In some examples, the CPU 102, integrated circuit(s) 103, connection circuitry 108, and I/O circuitry 110, are coupled to (e.g., mounted on) a printed circuit board (e.g., motherboard) 101.

CPU 102 enables processing of data and execution of instructions. The data and instructions can be stored on system memory 126, storage 146, and/or internal memory (not shown) of the CPU 102. In some examples, the CPU 102 includes one or more processor chiplets 104-1 . . . 104-N, which may be disposed on or over a package substrate 144. In some examples, the processor chiplets 104 can communicate with each other via interconnects routed through or on the package substrate 144 (e.g., through an interposer layer disposed between the package substrate 144 and the processor chiplets 104). In some examples, each processor chiplet 104 includes one or more cores (106, 108). Different processor chiplets 104 can have the same or different numbers of cores (106, 108). In the example of FIG. 1, processor chiplet 104-1 has K cores 106-1, 106-2, . . . 106-K, and processor chiplet 104-N has L cores (108-1, 108-2, . . . 108-L). The cores within an individual processor chiplet (e.g., cores 106-1, 106-2, . . . 106-K) can be homogeneous or heterogeneous. Likewise, the cores on different processor chiplets (e.g., cores 106-1 and 108-1) can be homogeneous or heterogeneous.

In the example of FIG. 1, the CPU 102 is configured to execute instructions of an operating system 142 and/or instructions (e.g., program code 140) of one or more applications. In some examples, the functionality of the program code may be implemented by one or more integrated circuits 103, one or more CPUs 102, one or more processor chiplets of a CPU 102, and/or one or more cores of a processor chiplet.

The data and instructions stored on any of the computer-readable storage media (e.g., system memory 126, storage 146, accelerator memory 138, internal or external caches of the CPU 102, etc.) can comprise computer-executable instructions implementing any suitable functionality.

In some examples, connection circuitry 108 communicatively couples CPUs 102 with each other, with integrated circuit(s) 103, and/or with external caches (e.g., level-2 (L2) cache, level-3 (L3) cache, etc.). Additionally or alternatively, the connection circuitry 108 can communicatively couple the CPUs 102 with I/O circuitry 110, which communicatively couples system memory, storage devices, and peripheral devices to each other and (via the connection circuitry 108) to the CPUs 102. The connection circuitry can couple the CPUs 102, external caches, and I/O circuitry 110 using any suitable network topology (e.g., a front-side bus, a back-side bus, etc.), and the coupled components can send and receive messages via the connection circuitry using any suitable communication protocol. In some examples, portions of the connection circuitry 108 can be integrated into the CPU(s) 102 and/or integrated circuit(s) 103.

In some examples, I/O circuitry 110 includes one or more memory controllers 112, one or more storage connectors 120, display circuitry 118, one or more peripheral connectors 124, and a peripheral switch 122. The memory controller(s) 112 can be configured to control the flow of data to and from the system memory 126. The storage connector(s) 120 can be configured to control the flow of data to and from the storage 146. The display circuitry 118 can be configured to send visual data (e.g., user interface data, image data, video data, etc.) to the display 128, which can be configured to display the visual data. In some examples, the display circuitry 118 can also be configured to receive data representing user input from the display 128 (e.g., in cases where the display 128 includes a touchscreen). In some examples, portions of the I/O circuitry 110 can be integrated into a motherboard and/or motherboard chipset (e.g., I/O circuitry 110) of the computer system 100.

Each of the peripheral connectors 124 may be configured to physically connect and communicatively couple the I/O circuitry 110 to a peripheral device. Any suitable type of peripheral device can be connected to a peripheral connector 124 including, without limitation, an I/O device 130 (e.g., an input device, output device, or input/output device), an accelerator 134, etc. Some non-limiting examples of an input device can include a mouse, keyboard, scanner, video game controller, microphone, webcam, etc. Some non-limiting examples of an output device can include a display, printer, speakers, headphones, earbuds, etc. Some non-limiting examples of an input/output device can include a storage device (e.g., disk drive, solid-state drive, universal serial bus (USB) flash drive, memory card, tape drive, etc.), a networking device (e.g., modem, router, gateway, network adapter, access point, etc.), etc. A networking adapter can be any suitable hardware and/or software to enable the computer system 100 to communicate via wires and/or wirelessly with any other suitable computing system over any suitable computing network. The computing network can include wireless access points, switches, routers, gateways, and/or other networking equipment as well as any suitable wired and/or wireless communication medium or media for exchanging data between two or more computers, including the Internet. Optionally, an I/O device can include one or more registers 132. In some examples, the I/O circuitry 110 can control the operation of an I/O device 130 by writing suitable data to one or more of the I/O device's registers, and/or can monitor the status of an I/O device 130 by reading the contents of one or more of the I/O device's registers.

Some non-limiting examples of an accelerator 134 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc. In some examples, an accelerator 134 includes one or more registers 136 and memory 138. In some examples, the I/O circuitry 110 can control the operation of an accelerator 134 by writing suitable data to one or more of the accelerator's registers, and/or can monitor the status of an accelerator 134 by reading the contents of one or more of the accelerator's registers.

The peripheral switch 122 can be configured to switch packets sent to or from the peripheral devices. Any suitable type of peripheral connector(s) 124 and peripheral switch 122 can be used including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc.

As described above computer system 100 can have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device can receive input information through speech recognition or in other audible format.

In some examples, computer system 100 further includes a voltage regulator 160. In some examples, the voltage regulator 160 receives power supply signals 152 (e.g., unregulated or insufficiently regulated power supply signals) from a power supply 150, and provides supply signal(s) 184 (e.g., 184a-c) with regulated voltage(s) to CPU(s) 102, integrated circuit(s) 103, I/O circuitry 110, any other components of the computer system 100, or any subset thereof. In some examples, the power supply 150 is a direct current (DC) power supply, and the signals provided by the power supply 150 are DC power supply signals 152. Some non-limiting examples of power supplies 150 can include one or more batteries (e.g., rechargeable batteries), an alternating current (AC) to DC power adapter (e.g., a power adapter for a mobile computing device), etc. In some examples, the voltage regulator 160 includes a voltage regulator (VR) controller 170 and a voltage regulator (VR) device 180. In some examples, the VR controller 170, the VR device 180, both components, or neither component is physically attached to (e.g., mounted on) a motherboard of computer system 100.

In some examples, the VR controller 170 of the voltage regulator 160 is configured to control the operation of the VR device 180. For example, the VR controller 170 can control the number of regulated supply signals 184 provided by the VR device 180 (up to a maximum number of regulated supply signals that the VR device 180 is capable of providing), the amplitudes of the voltages and/or currents of the regulated supply signals 184, etc. In some examples, the VR controller 170 controls the VR device 180 by providing one or more control signals 172 to the VR device 180. Such control signals 172 can include one or more power supply signals (e.g., with voltages determined by the VR controller 170), signals controlling the operation of transistors in the power stages of the VR device 180 (e.g., pulse-width modulated (PWM) signals controlling the duty cycles of such transistors), etc. In some examples, the VR controller 170 controls the VR device 180 based on feedback signals 182 from the VR device 180 indicating values of one or more parameters of the VR device 180. Some non-limiting examples of such parameters can include temperature(s) sensed by the VR device, voltages and/or currents of signals within the VR device 180 or produced by the VR device 180 (including the regulated supply signals 184), etc.

In some examples, the VR device 180 of the voltage regulator 160 is configured to provide one or more regulated power supply signals 184 to one or more components of the computer system 100. The VR device 180 can provide each regulated power supply signal 184 with any suitable voltage (e.g., 1 μV to 120 V) and/or any suitable current (e.g., 1 μA-500 A). In some examples, the VR device 180 is electrically coupled to one or more components of the computer system 100 via the printed circuit board 101 (e.g., motherboard), and the regulated power supply signals 184 are provided to the components of the computer system via traces, wires, or other conductive couplings of the printed circuit board. In some examples, the VR device 180 includes one or more sensors (e.g., voltage sensors, current sensors, temperature sensors, etc.) operable to sense values of one or more parameters of the VR device 180 and communicate those sensed values to the VR controller 170 via monitoring signals 182.

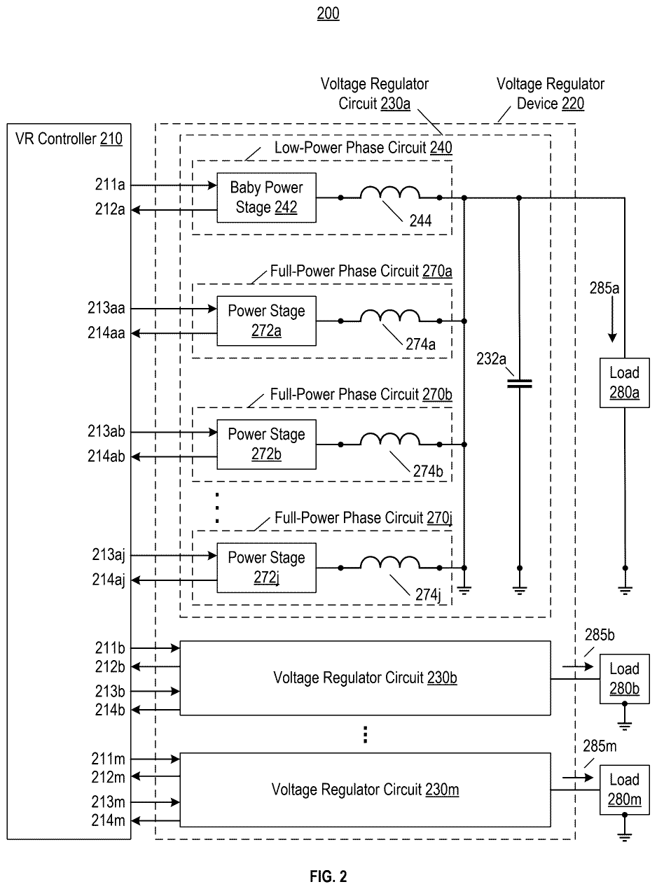

FIG. 2 illustrates one exemplary implementation of a voltage regulator 200 (e.g., voltage regulator 160). In some examples, the voltage regulator 200 includes a VR controller 210 (e.g., VR controller 170) and a VR device 220 (e.g., VR device 180). In some examples, the VR device 220 includes one or more voltage regulator (VR) circuits 230 (e.g., VR circuits 230a, 230b, . . . 230m). Each of the VR circuits 230 can be configured to provide a regulated power supply signal 285 (e.g., signals 285a-m) to a respective load 280 (e.g., loads 280a-m).

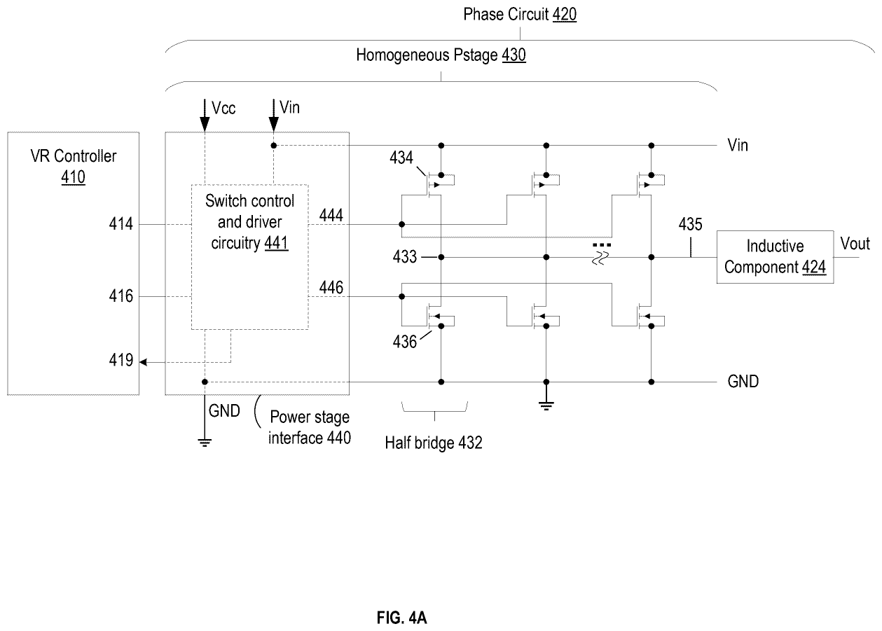

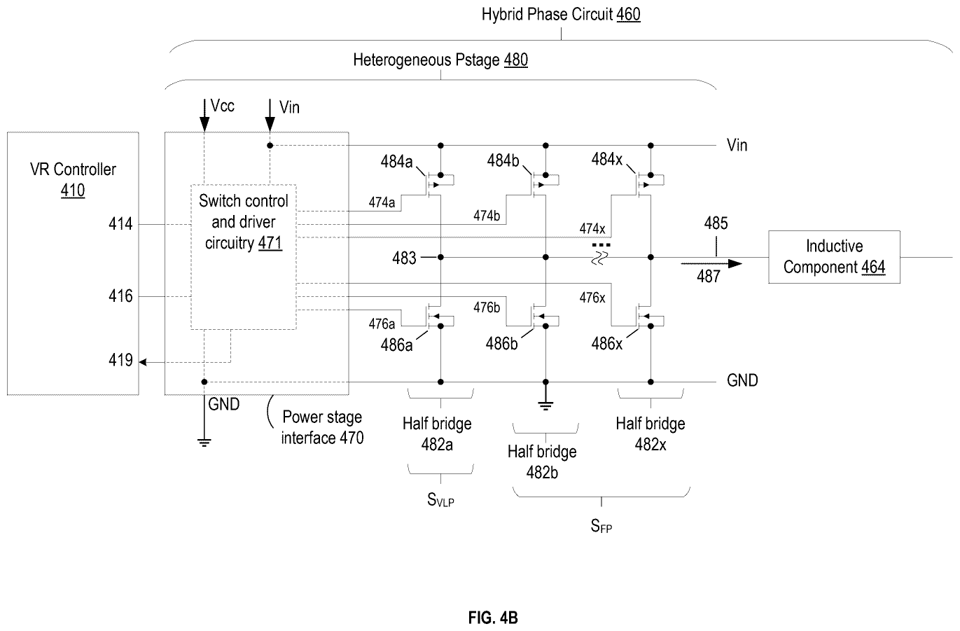

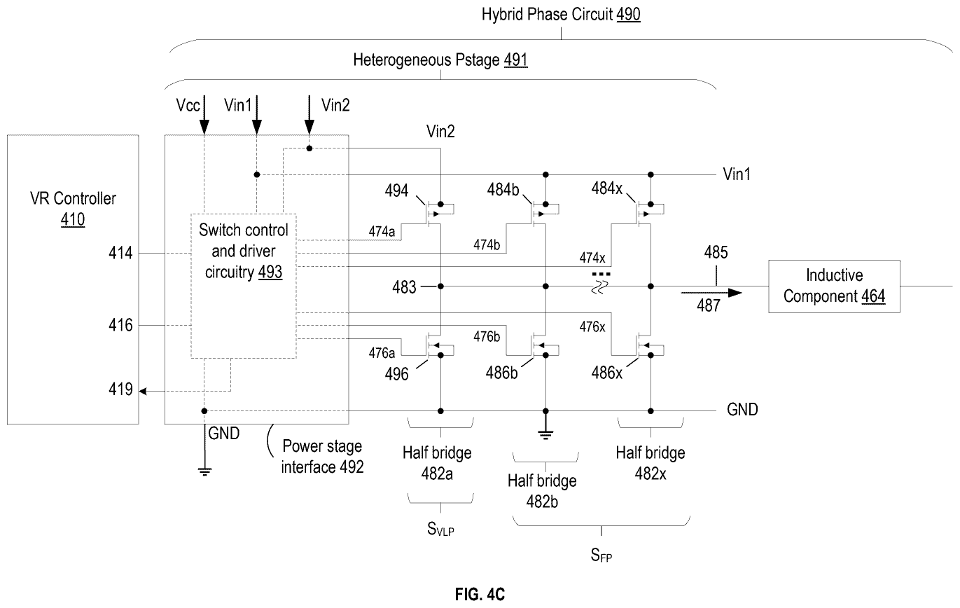

In some examples, voltage regulator circuit 230a includes a low-power phase circuit 240 (sometimes referred to as a “baby phase” circuit 240). The low-power phase circuit 240 can include a baby power stage 242 (e.g., a low-power, homogeneous power stage) and an inductive component 244 with high inductance. The baby power stage 242 can include one or more switches (e.g., MOSFETs or other transistors) and switch control and driver circuitry operable to control the amount of power (or current) provided by the low-power phase circuit 240 to the load 280a by selectively activating and deactivating the switches. The baby power stage 242 can have any suitable topology. Some non-limiting examples of baby power stages 242 for low-power phase circuits 240 are described herein with reference to FIG. 4A.

In some examples, the low-power phase circuit 240 is configured to provide a current of relatively low amplitude to the load 280a. For example, the low-power phase circuit 240 can be configured to provide a current having an amplitude less than an amplitude threshold (e.g., 5A, 3A, 2A, etc.). In some examples, the inductive component 244 has a relatively high inductance. For example, the inductive component 244 can have an inductance (e.g., 470 nH) greater than an threshold inductance (e.g., 200 nH). In some examples, the VR controller 210 provides one or more control signals 211a to control the operation of the low-power phase circuit 240. In some examples, the low-power phase circuit 240 provides one or more feedback signals 212a to the VR controller 210. Such feedback signals can indicate the values of one or more parameters of the low-power phase circuit, and the VR controller 210 can set or adjust the control signals 211a provided to the low-power phase circuit 240 based on the feedback signals 212a received from the low-power phase circuit 240.

In some examples, voltage regulator circuit 230a includes one or more full-power phase circuits 270 (e.g., full-power phase circuits 270a-j) (sometimes referred to as “full-power phases”). Each full-power phase circuit 270a-j can include a power stage 272a-j and an inductive component 274a-j (e.g., linear inductor). The power stage 272 can include one or more switches (e.g., MOSFETs or other transistors) operable to control the amount of power (or current) provided by the full-power phase circuit 270 to the load 280. The power stage 272 can have any suitable topology. Some non-limiting examples of power stages 272 for full-power phase circuits 270 are described herein with reference to FIG. 4A.

In some examples, each full-power phase circuit 270 is capable of providing current with large amplitudes to the load 280a. For example, each full-power phase circuit can be configured to provide current with an amplitude greater than a first amplitude threshold (e.g., 5A, 3A, 2A, etc.) and less than a second threshold amplitude (e.g., 35 A). In some examples, the inductive component 274 has a relatively low inductance. For example, the inductive component 274 can have an inductance (e.g., 100 nH) less than an threshold inductance (e.g., 200 nH). In some examples, the VR controller 210 provides control signals 213a to control the operation of the full-power phase circuits 270 (e.g., control signals 213aa-aj to control full-power phase circuits 270a-j). In some examples, the full-power phase circuits 270 provide feedback signals 214a to the VR controller 210 (e.g., feedback signals 214aa-aj provided by full-power phase circuits 270a-j). Such feedback signals can indicate the values of parameters of the full-power phase circuits, and the VR controller 210 can set or adjust the control signals 213 provided to a full-power phase circuit 270 based on the feedback signals 214 received from the full-power phase circuit 270.

In addition to a low-power phase circuit 240 and one or more full-power phase circuits 270, voltage regulator circuit 230a includes a capacitive component 232a (e.g., a capacitor). The inductive component 244 of the low-power phase circuit 240 can be coupled between the phase circuit's baby power stage 242 and a terminal of the capacitive component 232a. Likewise, the inductive component 274 of each full-power phase circuit 270 can be coupled between the phase circuit's power stage 272 and the terminal of the capacitive component 232a. The combination of each phase circuit's inductive component (244, 274) and the VR circuit's capacitive component 232a can form a filter that reduces ripple voltage and/or ripple current of the regulated supply signal provided by the respective phase circuit to the load 280a. In addition, the combination of each phase circuit (240, 270) and the VR circuit's capacitive component 232a can form a DC-to-DC converter (e.g., a buck converter, boost converter, buck-boost converter, cuk converter, etc.). The DC-to-DC converter can be configured to operate in a continuous mode and/or in a discontinuous mode.

The remaining VR circuits 230b-m can be similar, though not necessarily identical, to VR circuit 230a. For example, each VR circuit 230b-m can include zero or more low-power phase circuits and one or more full-power phase circuits with their outputs coupled to a terminal of a capacitive component. The VR circuits 230a-m can have the same or different numbers of low-power phase circuits, and the same or different numbers of full-power phase circuits. The VR controller 210 can provide control signals 211b-m to control the operation of the low-power phase circuits of the VR circuits 230b-m and control signals 213b-m to control the operation of the full-power phase circuits of the VR circuits 230b-m. Likewise, the low-power phase circuits of the VR circuits 230b-m can provide feedback signals 212b-m indicating the values of parameters of the low-power phase circuits, and the full-power phase circuits of the VR circuits 230b-m can provide feedback signals 214b-m indicating the values of parameters of the full-power phase circuits.

By activating a low-power phase circuit (e.g., baby phase circuit) in a voltage regulator circuit 230 and deactivating all other power phase circuits in that VR circuit, the voltage regulator 200 can operate with high power efficiency for light loads (e.g., loads less than 3A). However, the dedicated low-power phase circuits of the voltage regulator 200 can adversely affect the overall manufacturing cost and performance of the voltage regulator 200. In the example of FIG. 2, the VR controller 210 includes a large number of pins that are dedicated to controlling low-power phase circuits. These pins include the pins that drive the control signals 211 for the low-power phase circuits, the pins that receive the feedback signals 212 from the low-power phase circuits, and in some cases additional pins (e.g., to provide power supply signals to the low-power phase circuits). The pins dedicated to controlling the low-power phase circuits are unavailable to control additional full-power phase circuits 270. Thus, assuming the number of pins on the VR controller 210 is fixed, configuring the VR controller 210 to control the dedicated low-power phase circuits (baby phase circuits) of the VR device 220 decreases the number of full-power phase circuits 270 that the VR controller 210 can control, which ultimately reduces the maximum current the voltage regulator 200 can supply to a load and/or the number of distinct load currents 285 the voltage regulator 200 can provide simultaneously. This limitation can theoretically be addressed by increasing the pin count of the VR controller 210, but adding sufficient pins to the VR controller 210 can yield a significant increase in the controller's manufacturing cost.

In addition, configuring the VR controller 210 to drive the low-power phase circuits 240 of the voltage regulator 200 can make the VR controller 210 incompatible with other voltage regulators (e.g., voltage regulators that include only full-power phase circuits 270). The transistors of full-power phase circuits 270 generally operate at high voltages and are capable of conducting large currents, while the transistors of dedicated low-power phase circuits 240 generally operate at lower voltages and conduct smaller currents. Thus, the preferred driver circuits for low-power phase circuits 240 (e.g., the circuits of the VR controller 210 that provide the control signals 211 for the low-power phase circuits) and the preferred driver circuits for full-power phase circuits 270 (e.g., the circuits of the VR controller 210 that provide the control signals 213 for the full-power phase circuits) may be fabricated using different semiconductor fabrication processes suited to low-power transistors and high-power transistors, respectively. Integrating driver circuits fabricated using different semiconductor fabrication processes into the same VR controller 210 can significantly increase both the cost and complexity of the VR controller 210, and the driver circuits for the low-power phase circuits may be incapable of controlling full-power phase circuits of the voltage regulator 200 or other VRs.

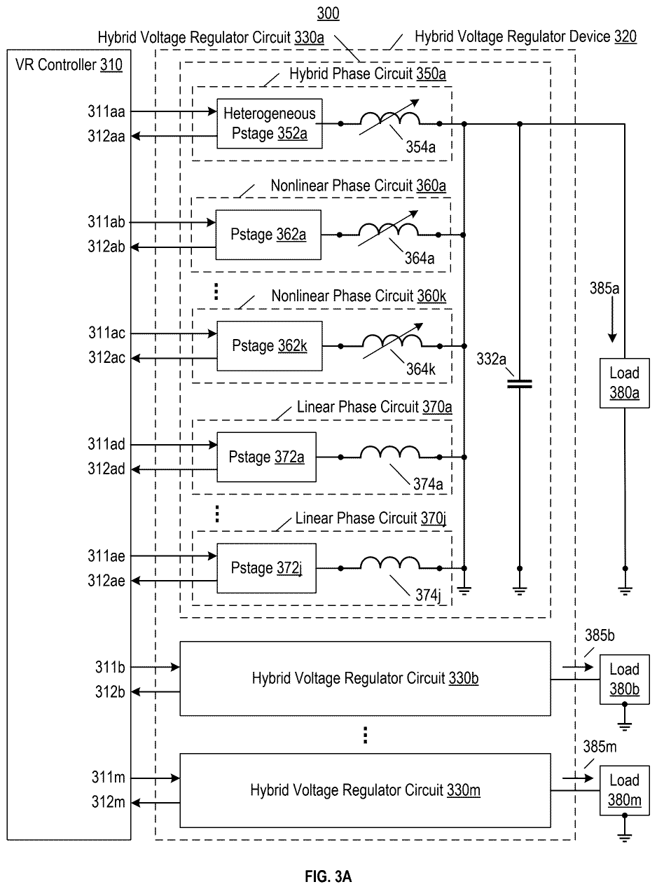

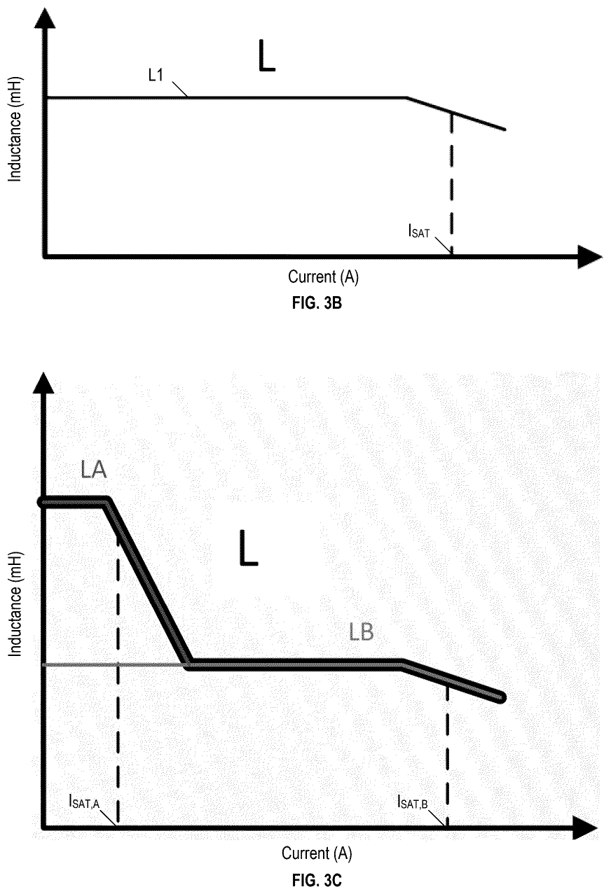

FIG. 3A illustrates one exemplary implementation of a hybrid voltage regulator (HVR) 300 (e.g., voltage regulator 160). In some examples, the HVR 300 includes a VR controller 310 (e.g., VR controller 170) and a hybrid voltage regulator (HVR) device 320 (e.g., VR device 180). In some examples, the HVR device 320 includes one or more HVR circuits 330 (e.g., HVR circuits 330a, 330b, . . . 330m). Each of the HVR circuits 330 can be configured to provide a regulated power supply signal 385 (e.g., signals 385a-m) to a respective load 380 (e.g., loads 380a-m).

In some examples, HVR circuit 330a includes at least one hybrid phase circuit 350a. The hybrid phase circuit 350a can include a heterogeneous power stage (“Pstage”) 352a and a nonlinear inductive component 354a (e.g., a nonlinear inductor). The heterogeneous Pstage 352a can include one or more switches (e.g., MOSFETs or other transistors) and switch control and driver circuitry operable to control the amount of power (or current) provided by the hybrid phase circuit 350a to the load 380a by selectively activating and deactivating subsets of the switches. The heterogeneous Pstage 352a can have any suitable topology. Some non-limiting examples of heterogeneous Pstages 352a for hybrid phase circuits are described herein with reference to FIGS. 4B and 4C.

The hybrid phase circuit 350a can be multimodal (e.g., configured to operate in two or more distinct modes). In some examples, the hybrid phase circuit 350a can operate in a very-low-power mode, in which the hybrid phase circuit can efficiently provide a regulated power supply signal 385a having current with very low amplitude (e.g., amplitude less than a threshold amplitude TA1) to the load, and the inductance of the nonlinear inductive component 354a is relatively high (e.g., greater than a threshold inductance). The threshold amplitude TA1 of the ‘very low’ current can be between 1 A and 5 A (e.g., 2 A, 3 A, etc.) or any other suitable value. The threshold inductance can be 100 nH or any other suitable value. In some examples, in the very-low-power mode, the supply voltage provided to the switches of the heterogeneous Pstage is relatively low (e.g., less than or equal to a suitable voltage threshold, such as a threshold between 3 V and 6 V).

In some examples, the hybrid phase circuit 350a also can operate in a full-power mode, in which the hybrid phase circuit is capable of providing current with low, moderate, or high amplitude. ‘Low’ amplitude current can be current with amplitude greater than the threshold amplitude TA1 but less than a second threshold amplitude TA2 (e.g., 8 A). ‘Moderate’ amplitude current can be current with amplitude greater than the second threshold amplitude TA2 but less than a third threshold amplitude TA3 (e.g., 20 A). ‘High’ amplitude current can be current with amplitude greater than the third threshold amplitude TA3. The inductance of the nonlinear inductive component can be relatively low (e.g., less than a threshold inductance TI) or relatively high (e.g., greater than the threshold inductance TI), depending on the amplitude of the current provided by the hybrid phase circuit. The threshold inductance can be approximately 100 nH or any other suitable value. In some examples, in the full-power mode, the supply voltage provided to the switches of the heterogeneous Pstage is relatively high (e.g., greater than or equal to a suitable voltage threshold, such as a threshold between 9 V and 12 V).

When the hybrid phase circuit 350a operates in the very-low-power mode, the heterogeneous Pstage 352a can operate a subset of its switches at a relatively low frequency and deactivate the remaining transistors. Thus, in the very-low-power mode, the hybrid phase circuit 350a can provide a relatively small amount of current (e.g., less than the first threshold amplitude TA1) to the nonlinear inductive component 354a, which (in response to the small amount of current) exhibits a relatively high inductance (e.g., 470 nH). In contrast, when the hybrid phase circuit 350a operates in the full-power mode, the heterogeneous Pstage 352a can operate a stronger subset of its switches at a frequency suitable for supplying a relatively large amount of current (e.g., greater than the third threshold amplitude TA3). Thus, in the full-power mode, the hybrid phase circuit 350a can provide a relatively large amount of current to the nonlinear inductive component 354a, which (in response to the large amount of current) exhibits a relatively low inductance (e.g., 100 nH). In this way, the hybrid phase circuit 350a can exhibit high power efficiency in the very-low-power mode, while also being capable of providing large amounts of current in the full-power mode.

Further extending the scope of the HVR circuit's high efficiency to somewhat heavier loads (e.g., load currents greater than TA1 but less than TA2) can be beneficial. Optionally, in some examples, HVR circuit 330a also includes one or more nonlinear phase circuits 360 (e.g., nonlinear phase circuits 360a-k). Each nonlinear phase circuit can be configured to efficiently provide current with relatively low amplitude. Each nonlinear phase circuit 360 can include a power stage (Pstage) 362 (e.g., a homogeneous Pstage) and a nonlinear inductive component 364 (e.g., nonlinear inductor). The Pstage 362 can include one or more switches (e.g., MOSFETs or other transistors) and switch control and driver circuitry operable to control the amount of power (or current) provided by the nonlinear phase circuit 360 to the load 380 by selectively activating and deactivating the switches. The PStage 362 can have any suitable topology. Some non-limiting examples of homogeneous Pstages are described herein with reference to FIG. 4A.

In some examples, the nonlinear phase circuit 360 is capable of providing current with low, moderate, or high amplitude. The inductance of the nonlinear inductive component 364 can be relatively low (e.g., less than a threshold inductance TI) or relatively high (e.g., greater than the threshold inductance TI), depending on the amplitude of the current provided by the nonlinear phase circuit. The threshold inductance can be approximately 100 nH or any other suitable value.

In this way, the nonlinear phase circuit 360 can extend the scope of the HVR circuit's highest-efficiency operation to include not only very-low-power loads (e.g., load currents less than the first threshold amplitude TA1), but also low-power loads (e.g., load currents less than the second threshold amplitude TA2), while also being capable of providing large amounts of current. However, due to the relatively high inductance of the inductive components 354a and 364 of the hybrid phase circuit 350a and the nonlinear phase circuits 360, these phase circuits'responses (e.g., “transient responses”) to sudden increases (e.g. “spikes”) in demand for load current can be somewhat sluggish.

In some examples, HVR circuit 330a further includes one or more linear phase circuits 370 (e.g., linear phase circuits 370a-j). Each linear phase circuit 370 can be configured to respond very rapidly (e.g., nearly instantaneously) to spikes in demand for load current (e.g., load current with moderate to high amplitude). Each linear phase circuit 370 can include a power stage (Pstage) 372 (e.g., a homogeneous Pstage) and a linear inductive component 374 (e.g., linear inductor). The power stage 372 can include one or more switches (e.g., MOSFETs or other transistors) and switch control and driver circuitry operable to control the amount of current provided by the linear phase circuit 370 to the load 380. The power stage 372 can have any suitable topology. Some non-limiting examples of power stages 372 are described herein with reference to FIG. 4A. The inductance of the linear inductive component can be relatively low (e.g., less than a threshold inductance TI). The threshold inductance can be approximately 100 nH or any other suitable value.

In addition to hybrid phase circuit(s) 350, nonlinear phase circuit(s) 360, and linear phase circuit(s) 370, HVR circuit 330a includes a capacitive component 332a (e.g., a capacitor). The inductive component 354 of each hybrid phase circuit 350 can be coupled between the phase circuit's heterogeneous Pstage 352 and a terminal of the capacitive component 332a. Likewise, the inductive component 364 of each nonlinear phase circuit 360 can be coupled between the phase circuit's Pstage 362 and the terminal of the capacitive component 332a. Likewise, the inductive component 374 of each linear phase circuit 370 can be coupled between the phase circuit's Pstage 372 and the terminal of the capacitive component 332a. The combination of each phase circuit's inductive component (354, 364, 374) and the HVR circuit's capacitive component 332a can form a filter that reduces ripple voltage and/or ripple current of the regulated supply signal 385 provided by the HVR circuit 330a to the load. In addition, the combination of each phase circuit (350, 360, 370) and the HVR circuit's capacitive component 332a can form a DC-to-DC converter (e.g., a buck converter, boost converter, buck-boost converter, cuk converter, etc.). The DC-to-DC converter can be configured to operate in a continuous mode and/or in a discontinuous mode.

In some examples, the VR controller 310 provides control signals 311a to control the operation of the phase circuits (350a, 360a-I, 370a-j) of the HVR circuit 330a. For example, the VR controller 310 can provide one or more control signals 311aa to control hybrid phase circuit 350a, one or more control signals 311ab-ac to control nonlinear phase circuit(s) 360a-k, and one or more control signals 311ad-ae to control linear phase circuit(s) 370a-j). In some examples, the phase circuits (350a, 360a-i, 370a-j) of the HVR circuit 330a provide feedback signals 312a to the VR controller to indicate the values of parameters of the phase circuits (350a, 360a-i, 370a-j). For example, the hybrid phase circuit 350a can provide one or more feedback signals 312aa, the nonlinear phase circuits 360a-k can provide one or more feedback signals 312ab-ac, and the linear phase circuits 370a-j can provide one or more feedback signals 312ad-ae. In some examples, the VR controller 310 can set or adjust the control signals 311 provided to HVR circuit 330a based on the feedback signals 312 received from the HVR circuit 330a.

Some examples of the HVR circuit 330a have been described. In some examples, the HVR circuit 330a includes (1) at least one hybrid phase circuit 350a and (2) one or more nonlinear phase circuits 360 having homogeneous Pstages and/or one or more linear phase circuits 370 having homogeneous Pstages. Other configurations of the HVR circuit 330a are possible.

The remaining HVR circuits 330b-m can be similar, though not necessarily identical, to HVR circuit 330a. For example, each HVR circuit 330b-m can include one or more hybrid phase circuits 350, nonlinear phase circuits 360, and/or linear phase circuits 370 with their outputs coupled to a terminal of a shared capacitive component. The VR circuits 330a-m can have the same or different numbers of hybrid phase circuits, nonlinear phase circuits, and/or linear phase circuits. The VR controller 310 can provide control signals 311b-m to control the operation of the phase circuits of the HVR circuits 330b-m. Likewise, the phase circuits of the HVR circuits 330b-m can provide feedback signals 312b-m indicating the values of parameters of the power stages. In some examples, the HVR device 320 includes one or more VR circuits 230.

The HVR's use of at least one hybrid phase circuit can address many of the shortcomings associated with the use of dedicated “baby phases.” The hybrid phase circuit 350 can function multi-modally as a very-low-power stage or a full-power stage, so the pins used by the VR controller 310 to drive the hybrid phase circuit 350 need not be dedicated to driving a very-low-power stage. Thus, replacing one or more full-power phase circuits of a voltage regulator with hybrid phase circuits does not necessarily reduce the maximum current the voltage regulator can supply to a load, and does not necessitate the addition of more pins to the VR controller. Furthermore, as described in further detail below, the heterogeneous power stage 352a of the hybrid phase circuit can be implemented such that the VR controller 310 can use the same driver circuits and the same control logic to drive hybrid phase circuits and other phase circuits. Thus, replacing one or more full-power stages of a voltage regulator with hybrid phase circuits need not unduly increase the manufacturing cost or complexity of the VR controller, and VR controllers suitable for controlling the HVR can also be used to control conventional voltage regulators that have no hybrid phase circuits.

In some examples, the HVR includes at least one hybrid phase circuit and at least one nonlinear phase circuit. In some examples, such configurations of the HVR can exhibit high efficiency operation not only for very-low-power loads (e.g., loads of 3 A or less), but also for low-power loads (e.g., loads of 3-8 A). In this way, the HVR can exhibit high efficiency operation for the loads processed by some mobile devices more than 90% of the time. In some examples, the HVR further includes at least one linear phase circuit (e.g., a phase circuit with a linear inductive component). In some examples, such configurations of the HVR can use the linear phase circuit(s) to respond rapidly to fluctuations in demand for load current.

In some examples, the VR controller 310 can control the HVR device 320 (e.g., an HVR circuit 330a of the HVR device 320) to efficiently provide regulated power supply signals 385 having currents suitable for very-low-power loads (e.g., loads less than 3 A) and low-power loads (e.g., loads less than 8 A), and to rapidly respond to spikes in demand for load current. In some examples, the VR controller 310 can control the hybrid phase circuit 350a to operate in a first mode (e.g., very-low-power mode) during a first time period based on the amplitude of the load current of the regulated power supply signal 385a (or the amplitude of the current provided by the hybrid phase circuit 350a to the load) being less than a threshold amplitude (e.g., TA1) during the first time period, and can control the hybrid phase circuit 350a to operate in a second mode (e.g., full-power mode) during a second time period based on the amplitude of the load current of the regulated power supply signal 385a (or the amplitude of the current provided by the hybrid phase circuit 350a to the load) being greater than another threshold amplitude (e.g., TA2) during the second time period.

In some examples, the VR controller 310 includes control circuits configured to provide the control signals 311 to the switch control and driver circuitry of the Pstages of the phase circuits of the HBR device 320. These controls signals can include pulse-width modulated (PWM) signals that control the duty cycles of the switches of the phase circuits. In some examples, those PWM signals determine the amplitude of the current provided by the hybrid phase circuit 350a and the operating mode of the hybrid phase circuit 350a (e.g., very-low-power mode or full-power mode). In some examples, those PWM control signals determine the amplitude of the current provided by the HVR circuit 330a and the operating mode of the HVR circuit 330a (e.g., very-low-power mode, low-power mode, moderate-power mode, or full-power mode).

In some examples, the VR controller 310 determines the operating mode of the HVR circuit 330a based on whether one or more parameters of the HVR circuit 330a satisfy one or more criteria. In some examples, the parameters of the HVR circuit 330a can include, without limitation, an amplitude of a load current of a regulated power supply signal 385a provided by the HVR circuit 330a. In some examples, the one or more criteria relate to relationships between the amplitude of the load current and one or more amplitude thresholds (e.g., TA1, TA2, TA3) or amplitude ranges (e.g., less than TA1, between TA1 and TA2, between TA2 and TA3, or greater than TA3).

In some examples, the VR controller 310 operates the HVR circuit 330a in a full-power mode based on the amplitude of the load current of the regulated power supply signal 385a exceeding the third amplitude threshold TA3 (e.g., 20 A). In some examples, when the HVR circuit 330a operates in the full-power mode, the hybrid phase circuit 350a, at least one nonlinear phase circuit 360, and at least one linear phase circuit 370 (e.g., four linear phase circuits 370) are activated, and the switches of the activated phase circuits switch at a relatively high frequency (e.g., greater than 600 kHz). In some examples, the regulated power signals provided by the hybrid phase circuit 350a and the nonlinear phase circuits(s) 360 are uniformly interleaved with a phase separation of approximately (1+num_NLS)/360 degrees, where num_NLS is the number of activated nonlinear phase circuits. In some examples, the regulated power signals provided by the linear phase circuits 370 are uniformly interleaved with a phase separation of approximately LS/360 degrees, where LS is the number of activated linear phase circuits.

In some examples, the VR controller 310 operates the HVR circuit 330a in a moderate-power mode based on the amplitude of the load current of the regulated power supply signal 385a being between the second amplitude threshold TA2 (e.g., 8 A) and the third amplitude threshold TA3 (e.g., 20 A). In some examples, when the HVR circuit 330a operates in the moderate-power mode, the hybrid phase circuit 350a and at least one nonlinear phase circuit 360 are activated, any remaining nonlinear phase circuits 360 and the linear phase circuits 370 are deactivated, and the switches of the activated phase circuits switch at a moderate frequency (e.g., 300-600 kHz). In some examples, the regulated power signals provided by the hybrid phase circuit 350a and the nonlinear phase circuit(s) 360 are uniformly interleaved with a phase separation of approximately (1+num_NLS)/360 degrees, where num_NLS is the number of activated nonlinear phase circuits.

In some examples, the VR controller 310 operates the HVR circuit 330a in a low-power mode based on the amplitude of the load current of the regulated power supply signal 385a being between the first amplitude threshold TA1 (e.g., 3 A) and the second amplitude threshold TA2 (e.g., 8 A). In some examples, when the HVR circuit 330a operates in the low-power mode, the hybrid phase circuit 350a and a nonlinear phase circuit 360 are activated, the remaining nonlinear phase circuits and the linear phase circuits 370 are deactivated, and the switches of the activated phase circuits switch at a low frequency (e.g., less than 300 kHz) or do not switch. In some examples, the regulated power signals provided by the hybrid phase circuit 350a and the nonlinear phase circuit 360a are uniformly interleaved with a phase separation of approximately 180 degrees.

In some examples, the VR controller 310 operates the HVR circuit 330a in a very-low-power mode based on the amplitude of the load current of the regulated power supply signal 385a being less than the first amplitude threshold TA1 (e.g., 3 A). In some examples, when the HVR circuit 330a operates in the very-low-power mode, the hybrid phase circuit 350a is activated, all the nonlinear and linear phase circuits are deactivated, and the switches of the hybrid phase circuit switch at a low frequency (e.g., less than 300 kHz) or do not switch.

Some configurations have been described in which phase circuits are “activated” or “deactivated.” A phase circuit can be considered “activated” if the stage is conducting non-negligible current through its inductive component, or if a terminal of the phase circuit's inductive component is conductively coupled to a power supply rail through at least one switch in the phase circuit's power stage. A phase circuit that is not activated is “deactivated.”

Some configurations have been described in which phase circuits include linear or nonlinear inductive components (e.g., inductors). FIGS. 3B and 3C illustrate examples of inductance-current (L-I) curves of a linear inductor and a nonlinear inductor, respectively. As FIG. 3B shows, a linear inductor has a single saturation point I_{SAT} (e.g., 35 A). For currents with amplitudes lower than the saturation point, the inductance of the linear inductor is L1. For currents with amplitudes higher than the saturation point, the inductance of the linear inductor decreases significantly. As FIG. 3C shows, a nonlinear inductor has two saturation points I_{SAT,A} and I_{SAT,B}. For currents with amplitudes lower than the first saturation point I_{SAT,A} (e.g., 3-5 A), the inductance of the nonlinear inductor is LA (e.g., 470 nH). For currents with amplitudes higher than the first saturation point I_{SAT,A} and lower than the second saturation point I_{SAT,B} (e.g., 35 A), the inductance of the nonlinear inductor is LB (e.g., 100 nH). For currents with amplitudes higher than the second saturation point I_{SAT,B}, the inductance of the nonlinear inductor decreases significantly. A nonlinear inductive component (354, 364) can be implemented using any suitable components including, without limitation, (1) two separate linear inductors with nominal inductance values of LA and LB connected in series, (2) an inductor with two gaps in the same ferrite core, or (3) an inductor with mixed core material (e.g., a ferrite core mixed with a metal alloy).

In some examples, using a nonlinear inductive component in a hybrid phase circuit or nonlinear phase circuit facilitates the efficient provision of low currents by the phase circuit, because the inductive component's high inductance (LA) at low currents allows the power stage's switches to provide low currents while operating at low frequency, thereby improving power efficiency for light loads. When the load current increases (e.g., temporarily spikes or sustains a high amplitude), the inductive component's inductance drops to the lower value (LB), which facilitates a rapid response by the phase circuit to the increased demand for load current, thereby providing acceptable dynamic performance.

Some examples have been described in which a low-power phase circuit (baby phase) 240, full-power phase circuit 270, nonlinear phase circuit 360, or linear phase circuit 370 includes a power stage (e.g., homogeneous power stage) that controls the amount of power (or current) provided by the phase circuit to the load. FIG. 4A illustrates one exemplary implementation of a homogeneous power stage (Pstage) of a phase circuit 420 (e.g., a low-power phase circuit (baby phase) 240, full-power phase circuit 270, nonlinear phase circuit 360, or linear phase circuit 370). Other implementations of the power stage 430 are possible.

In some examples, a homogeneous Pstage 430 includes one or more high-side switches 434 (e.g., p-type MOSFETs) configured to couple the switch node 435 of the power stage to a supply voltage rail (Vin) (thereby delivering power and/or current to the switch node 435), and one or more low-side switches 436 (e.g., n-type MOSFETs) configured to couple the switch node 435 of the power stage to ground (GND) (thereby delivering power and/or current from the switch node 435 to ground). In some examples, pairs of high-side switches 434 and low-side switches 436 are connected in a half bridge configuration, with the conducting path (e.g., channel) of the high-side switch 434 coupled between the supply voltage rail (Vin) and the half bridge's switch node 433, and the conducting path (e.g., channel) of the low-side switch 436 coupled between the half bridge's switch node 433 and ground (GND). The power stage 430 can include one or more half bridges 432, with their switch nodes 433 coupled to each other and to the switch node 435 of the Pstage. Other arrangements of the high- and low-side switches are possible.

In some examples, the power stage 430 further includes power stage interface 440. In some examples, the power stage interface 440 includes switch control and driver circuitry 441. In some examples, the power stage interface 440 receives power supply signals (e.g., supply voltage Vin, power supply bias voltage Vcc, and ground reference GND) from a power supply, and provides those power supply signals to the switch control and driver circuitry 441 and to the switches (434, 436) of the power stage 430. In some examples, the power stage interface 440 receives control signals (414, 416) from the VR controller 410. In some examples, the control signals (414, 416) indicate the amount of power (or current) to be delivered to the power stage's switch node 435, or delivered from the power stage's switch node 435 to ground. In some examples, the control signals (414, 416) indicate the duty cycles at which the switches (434, 436) of the power stage 430 are to be operated. The power stage interface 440 can provide the control signals (414, 416) as inputs to the switch control and driver circuitry 441. In some examples, the switch control and driver circuitry 441 generates control signals (444, 446) for the power stage 430 based on the control signals (414, 416) provided by the VR controller 410. In some examples, the control signals 444 (e.g., pulse-width modulated (PWM) control signals) are provided to the control terminals (e.g., gates) of the high-side switches 434, such that the control signals 444 determine the duty cycles of the high-side switches 434. In some examples, the control signals 446 (e.g., pulse-width modulated (PWM) control signals) are provided to the control terminals (e.g., gates) of the low-side switches 436, such that the control signals 446 determine the duty cycles of the low-side switches 436.

In some examples, the power stage interface 440 provides one or more feedback signals 419 to the VR controller 410. The feedback signal(s) can indicate the values of one or more parameters of the power stage 430. Some non-limiting examples of such parameters can include a temperature of the power stage 430, voltages and/or currents of one or more signals within the power stage 430 or produced by the power stage 430 (e.g., the amplitude of the current delivered to switch node 435, etc. The feedback signals can be provided by the switch control and driver circuitry 441. In some examples, the switch control and driver circuitry 441 includes current sensing circuitry that senses the amplitudes of one or more currents in the power stage 430 (e.g., the current at switch node 435, the currents flowing through each of the half bridges 432, etc.) and provides the feedback signal(s) 419 indicating the amplitudes of the sensed current(s). In some examples, the power stage interface 440 includes a temperature sensor, which provides a feedback signal 419 indicating the temperature of the power stage 430.

In some examples, all high-side switches 434 of the homogeneous Pstage 430 are controlled by the same control signal 444, and all low-side switches 436 of the homogeneous Pstage 430 are controlled by the same control signal 446. In some examples, all high-side switches 434 of the homogeneous Pstage 430 are activated simultaneously and deactivated simultaneously, and all low-side switches 436 of the homogeneous Pstage 430 are activated simultaneously and deactivated simultaneously. In some examples, all half bridges 432 of the homogeneous Pstage 430 are supplied by the same voltage supply rail (Vin). The homogeneous Pstage 430 may be homogeneous in other ways.

FIG. 4B illustrates one exemplary implementation of a heterogeneous power stage (Pstage) of a hybrid phase circuit 460 (e.g., a hybrid phase circuit 350). The heterogeneous Pstage 480 can include one or more high-side switches 484a-x (e.g., p-type MOSFETs) configured to couple the switch node 485 of the power stage to a supply voltage rail (Vin) (thereby delivering power and/or current to the switch node 485), and one or more low-side switches 486a-x (e.g., n-type MOSFETs) configured to couple the switch node 485 of the power stage to ground (GND) (thereby delivering power and/or current from the switch node 485 to ground). In some examples, pairs of high-side switches and low-side switches (e.g., 484a and 486a) are connected in a half bridge configuration, with the conducting path (e.g., channel) of the high-side switch 486a coupled between the supply voltage rail (Vin) and the half bridge's switch node 483, and the conducting path (e.g., channel) of the low-side switch 486a coupled between the half bridge's switch node 483 and ground (GND). The power stage 480 can include one or more half bridges 482a-x, with their switch nodes 483 coupled to each other and to the switch node 485 of the power stage. Other arrangements of the high- and low-side switches are possible.

In some examples, the heterogeneous Pstage 480 further includes power stage interface 470. In some examples, the power stage interface 470 includes switch control and driver circuitry 471. In some examples, the power stage interface 470 receives power supply signals (e.g., supply voltage Vin, power supply bias voltage Vcc, and ground reference GND) from a power supply, and provides those power supply signals to the switch control and driver circuitry 471 and to the switches (484a-x, 486a-x) of the heterogeneous Pstage 480. In some examples, the power stage interface 470 receives control signals (414, 416) from the VR controller 410. In some examples, the control signals (414, 416) indicate the amount of power (or current) to be delivered to the Pstage's switch node 485, or delivered from the Pstage's switch node 485 to ground. In some examples, the control signals (414, 416) indicate the duty cycles at which the switches (484a-x, 486a-x) of the power stage 480 are to be operated. The power stage interface 470 can provide the control signals (414, 416) as inputs to the switch control and driver circuitry 471. In some examples, the switch control and driver circuitry 471 generates control signals (474a-x, 476a-x) for the Pstage 480 based on the control signals (414, 416) provided by the VR controller 410. In some examples, the control signals 474a-x (e.g., pulse-width modulated (PWM) control signals) are provided to the control terminals (e.g., gates) of the high-side switches 484a-x, such that the control signals 474a-x determine the duty cycles of the high-side switches 484a-x. In some examples, the control signals 476a-x (e.g., pulse-width modulated (PWM) control signals) are provided to the control terminals (e.g., gates) of the low-side switches 486a-x, such that the control signals 476a-x determine the duty cycles of the high-side switches 486a-x.

In some examples, the power stage interface 470 provides one or more feedback signals 419 to the VR controller 410. The feedback signal(s) can indicate the values of one or more parameters of the power stage 480. Some non-limiting examples of such parameters can include a temperature of the power stage 480, voltages and/or currents of one or more signals within the power stage 480 or produced by the power stage 480 (e.g., the amplitude of the current delivered to switch node 485, etc. The feedback signals can be provided by the switch control and driver circuitry 471. In some examples, the switch control and driver circuitry 441 includes current sensing circuitry that senses the amplitudes of one or more currents in the power stage 430 (e.g., the current at switch node 435, the currents flowing through each of the half bridges 432, etc.) and provides the feedback signal(s) 419 indicating the amplitudes of the sensed current(s). In some examples, the power stage interface 440 includes a temperature sensor, which provides a feedback signal 419 indicating the temperature of the power stage 480.

In some examples, the power stage interface 470 provides an interface to the heterogeneous Pstage 480, which enables the VR controller 410 to control the heterogeneous Pstage 480 of the hybrid phase circuit 460 using the same number of pins and the same types of signals (e.g., control signals 414, 416) that the VR controller 410 uses to control other power stages (e.g., homogeneous Pstage 430) of other phase circuits (e.g., low-power phase circuits 240, full-power phase circuits 270, nonlinear phase circuits 360, linear phase circuits 370, etc.).

In some examples, the control terminals (e.g., gates) of the individual high-side switches 484a-x are independently driven by individual control signals 474a-x (e.g., pulse-width modulated (PWM) control signals) provided by the power stage interface 470, and the control terminals (e.g., gates) of the individual low-side switches 486a-x are independently driven by individual control signals 476a-x (e.g., PWM control signals) provided by the power stage interface 470, such that the power stage interface 470 can independently control each of the half bridges 482a-x. For example, when the hybrid phase circuit 460 is in a very-low-power mode, the power stage interface 470 can selectively activate a single half bridge 482a (and deactivate the other half bridges 482b-x), such that the amount of current supplied by the heterogeneous Pstage 480 in the very-low-power mode is limited by the characteristics of that half bridge 482a and controlled by the duty cycles of that half bridge's switches. In some examples, this half bridge 482a may be configured to conduct a current of very low amplitude (e.g., 2-3 A) when its high-side switch 484a is in the conducting state. Likewise, when the hybrid phase circuit 460 is in a full-power mode, the power stage interface 470 can activate all the half bridges 482a-x, or activate all the half bridges 482b-x that were inactive in the very-low-power mode and deactivate the half bridge 482a that was active in the very-low-power mode, such that the amount of current supplied by the heterogeneous Pstage 480 in the full-power mode is the sum of the currents provided by the activated half bridges.

In some examples, the half bridges 482a-x are logically divided into two subsets S_{VLP} and S_{FP}. When the hybrid phase circuit 460 is in the very-low-power mode, the half bridges in subset S_{VLP} can be activated and the half bridges in the subset S_{FP} can be deactivated. When the hybrid phase circuit 460 is in the full-power mode, the half bridges in subset S_{FP} can be activated and the half bridges in the subset S_{VLP} can be activated or deactivated. In some examples, the subset S_{VLP} consists of a single half bridge 482a, and the subset S_{FP} consists of the remaining half bridges 482b-x. In some examples, the subset S_{VLP} consists of a single half bridge 482a, and the subset S_{FP} includes all the half bridges 482a-x.

The control terminal(s) of the high-side switch(es) in the subset S_{VLP} (e.g., switch 484a) can be driven by the corresponding control signal(s) (e.g., control signal 474a) provided by the power stage interface 470, and the control terminal(s) of the low-side switch(es) in the subset S_{VLP} (e.g., switch 486a) can be driven by the corresponding control signal(s) (e.g., control signal 476a). Likewise, the control terminal(s) of the high-side switch(es) in the subset S_{FP} (e.g., switches 484b-x) can be driven by the corresponding control signal(s) (e.g., signals 474b-x) provided by the power stage interface 470, and the control terminal(s) of the low-side switch(es) in the subset S_{FP} (e.g., switches 486b-x) can be driven by the corresponding control signal(s) (e.g., control signals 476b-x). In this subset-based configuration, the power stage interface 470 can control each subset of half bridges using a single pair of control signals per subset, with the pair of control signals corresponding to a subset being supplied to the control terminals of all the half bridges in that subset.

Some embodiments of the switch control and driver circuitry 471 can generate control signals (474a-x, 476a-x) for the Pstage 480 based on the control signals (414, 416) provided by the VR controller 410 and/or based on values of one or more parameters of the power stage 480 (e.g., a temperature of the power stage 480, voltages and/or currents of one or more signals within the power stage 480 or produced by the power stage 480, the current 487 delivered to the switch node 485 of the Pstage 480, etc.). For example, when the switch control and driver circuitry 471 senses that the current 487 delivered to the switch node 485 satisfies first criteria (e.g., the amplitude of the current 487 is less than a first amplitude threshold TA1 (e.g., 3 A)), the switch control and driver circuitry 471 can configure the heterogeneous Pstage 480 to operate the hybrid phase circuit 460 in very-low-power mode by (1) providing control signals 474 to the control terminals of the high-side switches of the half bridges in subset S_{VLP} to activate those high-side switches with a suitable duty cycle for the very-low-power mode, (2) providing control signals 476 to the control terminals of the low-side switches of the half bridges in subset S_{VLP} to activate those low-side switches with a suitable duty cycle for the very-low-power mode, and (3) providing control signals (474, 476) to the half bridges in subset S_{FP} suitable for deactivating these half bridges (e.g., placing the switches of these half bridges in the non-conducting state).

Likewise, when the switch control and driver circuitry 471 senses that the current 487 satisfies second criteria (e.g., the current 487 has an amplitude greater than a first amplitude threshold TA1), the switch control and driver circuitry 471 can configure the heterogeneous Pstage 480 to operate the hybrid phase circuit 460 in full-power mode by (1) providing control signals 417 to the control terminals of the high-side switches of the half bridges in subset S_{FP} to activate those high-side switches with a suitable duty cycle for the full-power mode, (2) providing control signals 476 to the control terminals of the low-side switches of the half bridges in subset S_{FP} to activate those low-side switches with a suitable duty cycle for the full-power mode, and (3) providing control signals to the half bridges in subset S_{VLP} suitable for deactivating these half bridges (e.g., placing the switches of these half bridges in the non-conducting state). Alternatively, the switch control and driver circuitry 471 can configure the Pstage 480 to operate the hybrid phase circuit 460 in full-power mode by (1) providing control signals 474 to the control terminals of the high-side switches of all the half bridges in Pstage 480, and (2) routing control signals 476 to the control terminals of the low-side switches of all the half bridges in Pstage 480. The switch control and driver circuitry 471 can be implemented using digital circuits, programmable controllers, crossbar switches, and/or any other suitable components.

In some examples, the set S_{VLP} and the set S_{FP} are disjoint. In some examples, the number N1 of half bridges in the set S_{VLP} is an integer greater than or equal to 1 and less than the number N2 of half bridges in the set S_{FP}. In some examples, the amplitude of the current 487 provided by the hybrid phase circuit 460 when the high-side switch(es) of the half bridge(s) in the set S_{VLP} are switched with a duty cycle DC1 is less than the amplitude of the current 487 provided by the hybrid phase circuit 460 when the high-side switch(es) of the half bridge(s) in the set S_{FP} are switched with the same duty cycle DC1.

FIG. 4C illustrates another exemplary implementation of a heterogeneous power stage (Pstage) of a hybrid phase circuit 490. The heterogeneous Pstage 491 of FIG. 4C is similar to the heterogeneous Pstage 480 of FIG. 4B, with some notable differences. In some examples, the high-side switches 494 and low-side switches 496 in subset S_{VLP} of the half bridges are low-voltage switches (e.g., MOSFETs), capable of operating with a supply voltage Vin2 lower than the supply voltage Vin1 provided to the high-side switches 484 and low-side switches 486 in the subset S_{FP} of the half bridges. In addition, the power stage interface 492 can receive two supply voltages (Vin1 and Vin2) from the power supply unit, provide the higher supply voltage Vin1 to the half bridges in the subset S_{FP}, and provide the lower supply voltage Vin2 to the half bridges in the subset S_{VLP}. Thus, when the heterogeneous Pstage 491 operates the hybrid phase circuit 490 in the very-low-power mode, the power efficiency of the hybrid phase circuit 490 may be even higher than the power efficiency of the hybrid phase circuit 460.

In some examples, to deliver a particular amount of power (or current) to the switch node 485, switch control and driver circuitry 493 of Pstage 491 may operate the low-voltage switches (494, 496) of the half bridge(s) in the subset S_{VLP} with a first duty cycle, whereas switch control and driver circuitry 471 of Pstage 480 may deliver the same amount of power (or current) to the switch node 485 by operating the switches (474, 476) of the half bridge(s) in the subset S_{VLP} with a second, different duty cycle.

Examples have been described in which a Pstage includes high-side switches and low-side switches connected to form one or more (e.g., many) half bridges. Such an architecture may be advantageous when the switches are implemented as planar transistors (e.g., MOSFETs) and the voltage regulator is integrated onto a monolithic die. In some examples, the high-side switches and low-side switches can be implemented as trench MOSFETs, which can be connected to form two sets of half bridges.

FIG. 5 illustrates one exemplary method 500 for regulating a voltage of a power supply signal. In some examples, the method 500 can be performed by a hybrid phase circuit of a hybrid voltage regulator device. In some examples, the method 500 involves a heterogeneous power stage of a hybrid phase circuit of a HVR device producing a signal. In some examples, producing the signal includes performing steps 510 and 520 (described in further detail below. In some examples, the method 500 also involves providing the signal to a nonlinear inductive component coupled between the heterogeneous power stage of the hybrid phase circuit and a capacitive component of the HVR device.

In step 510, during a first time period, the hybrid phase circuit operates in a first mode (e.g., a very-low-power mode). In some examples, when the hybrid phase circuit operates in the first mode, the amplitude of the current delivered by the hybrid phase circuit is low (e.g., less than a threshold amplitude), and the inductance of the nonlinear inductive component of the hybrid phase circuit is high (e.g., greater than or equal to a first threshold inductance).

In step 520, during a second time period, the hybrid phase circuit operates in a second mode (e.g., a full-power mode). In some examples, when the hybrid phase circuit operates in the second mode, the amplitude of the current delivered by the hybrid phase circuit is high (e.g., greater than the threshold amplitude), and the inductance of the nonlinear inductive component of the hybrid phase circuit is low (e.g., less than or equal to a second threshold inductance).

In some examples, the threshold amplitude is equal to the lower saturation current (I_{SAT,A}) of the nonlinear inductor of the hybrid phase circuit. In some examples, the first threshold inductance is equal to the higher stable inductance value (L_{A}) of the nonlinear inductor, and the second threshold inductance is equal to the lower stable inductance value (L_{B}) of the nonlinear inductor.

In some examples, operating the hybrid phase circuit in the first mode includes activating at least one and at most N1 of the half bridges (or high-side switches) of the heterogeneous Pstage of the hybrid phase circuit and deactivating the other half bridges (or high-side switches). In some examples, operating the hybrid phase circuit in the second mode includes activating at least N2 of the half bridges (or high-side switches), wherein 1≤N1<N2.

In some examples, operating the hybrid phase circuit in the first mode includes activating a non-empty set S_{VLP} of the half bridges (or high-side switches) of the heterogeneous Pstage of the hybrid phase circuit and deactivating the other half bridges (or high-side switches). In some examples, operating the hybrid phase circuit in the second mode includes deactivating the set S_{VLP} of half bridges (or high-side switches) and activating the other half bridges (or high-side switches).

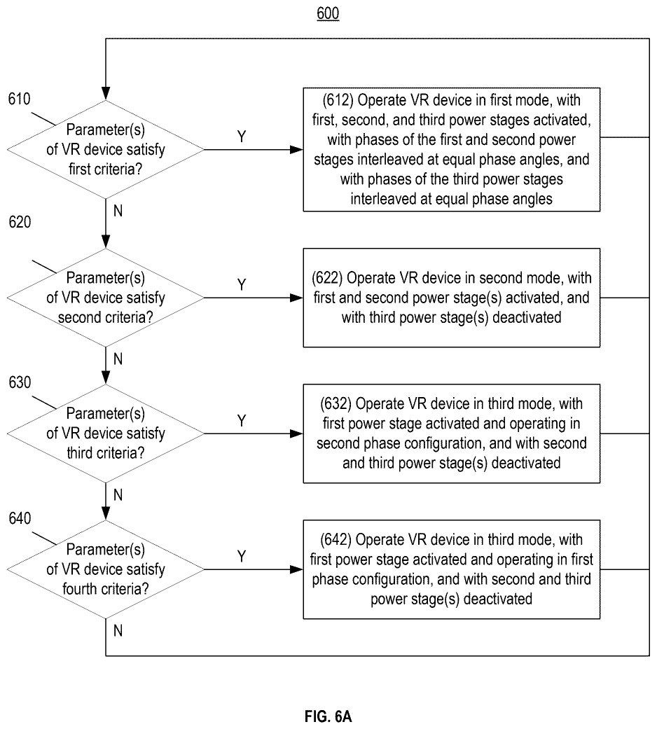

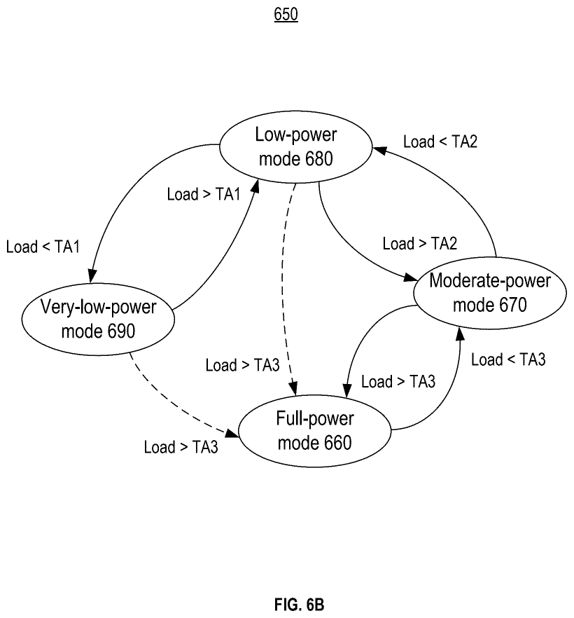

FIG. 6A illustrates another exemplary method 600 for regulating a voltage of a power supply signal. In some examples, the method 600 is performed by a hybrid voltage regulator (HVR) device. In some examples, the method 600 is performed by a VR controller and a hybrid voltage regulator device of a hybrid voltage regulator. In some examples, the method involves the VR controller determining the operating mode of a hybrid voltage regulator (HVR) circuit of the HVR device based on whether one or more parameters of the HVR circuit satisfy one or more criteria. In some examples, the parameters of the HVR circuit can include, without limitation, an amplitude of a load current delivered by the HVR circuit. In some examples, the one or more criteria relate to relationships between the amplitude of the load current and one or more amplitude thresholds (e.g., TA1, TA2, TA3) or amplitude ranges.

In some examples, the method 600 includes steps 610-642. In step 610, the VR controller determines whether one or more parameters of the HVR circuit satisfy first criteria (e.g., whether the amplitude of the load current delivered by the HVR circuit exceeds a third amplitude threshold TA3). If so, the VR controller performs step 612. In step 612, the VR controller operates the HVR circuit in a first mode (e.g., a full-power mode). Some non-limiting examples of operating the HVR circuit in the full-power mode are described herein. In some examples, when the HVR circuit operates in the full-power mode, the high-side switches of power stages of the active phase circuits may switch at a frequency greater than a first threshold frequency (e.g., 800 kHz or more).

In step 620, the VR controller determines whether one or more parameters of the HVR circuit satisfy second criteria (e.g., whether the amplitude of the load current delivered by the HVR circuit is between a second amplitude threshold TA2 and the third amplitude threshold TA3). If so, the VR controller performs step 622. In step 622, the VR controller operates the HVR circuit in a second mode (e.g., a moderate-power mode). Some non-limiting examples of operating the HVR circuit in the moderate-power mode are described herein. In some examples, when the HVR circuit operates in the moderate-power mode, the high-side switches of power stages of the active phase circuits may switch at a frequency between the first threshold frequency and a second threshold frequency (e.g., 300-800 kHz, 300-600 kHz, etc.).

In step 630, the VR controller determines whether one or more parameters of the HVR circuit satisfy third criteria (e.g., whether the amplitude of the load current delivered by the HVR circuit is between a first amplitude threshold TA1 and the second amplitude threshold TA2). If so, the VR controller performs step 632. In step 632, the VR controller operates the HVR circuit in a third mode (e.g., a low-power mode). Some non-limiting examples of operating the HVR circuit in the low-power mode are described herein. In some examples, when the HVR circuit operates in the low-power mode, the high-side switches of power stages of the active phase circuits may switch at a frequency between the second threshold frequency and a third threshold frequency (e.g., 0-300 kHz). In some examples, when the HVR circuit operates in the low-power mode, the high-side switches of power stages of the active phase circuits may operate in DC mode, such that the switches remain in the conducting state.

In step 640, the VR controller determines whether one or more parameters of the HVR circuit satisfy fourth criteria (e.g., whether the amplitude of the load current provided by the HVR circuit is less than the first amplitude threshold TA1). If so, the VR controller performs step 642. In step 642, the VR controller operates the HVR circuit in a fourth mode (e.g., a very-low-power mode). Some non-limiting examples of operating the HVR circuit in the very-low-power mode are described herein. In some examples, when the HVR circuit operates in the very-low-power mode, the high-side switches of power stage of the hybrid phase circuit may switch at a frequency between the second threshold frequency and the third threshold frequency (e.g., 0-300 kHz). In some examples, when the HVR circuit operates in the very-low-power mode, the high-side switches of power stage of the hybrid phase circuit may operate in DC mode, such that the switches remain in the conducting state.

When operating a multiphase, hybrid voltage regulator circuit 330a having M parallel power stages producing a supply signal in M phases, one approach is to uniformly interleave the phases of the signals produced by the M stages such that the phase separation between adjacent signals is approximately M/360 degrees. One purpose of such interleaving is to evenly distribute the pulses of current provided by the parallel power stages, such that the ripple in the load current produced by combining the current pulses is reduced.

FIG. 6B is a state transition diagram of another example method 650 for regulating a voltage of a power supply signal. In some examples, the method 650 is performed by a hybrid voltage regulator (HVR) device. In some examples, the method 650 is performed by a VR controller and a HVR device of a HVR. In some examples, the method involves the VR controller determining the operating mode of a HVR circuit of the HVR device based on whether one or more parameters of the HVR circuit satisfy one or more criteria. In some examples, the parameters of the HVR circuit can include, without limitation, an amplitude of a load current delivered by the HVR circuit. In some examples, the one or more criteria relate to relationships between the amplitude of the load current and one or more amplitude thresholds (e.g., TA1, TA2, TA3) or amplitude ranges.

In some examples, the HVR circuit can operate in multiple modes (e.g., full-power mode 660, moderate-power mode 670, low-power mode 680, and very-low-power mode 690). When the load current is less than TA1, the HVR circuit can operate in the very-low-power mode 690. Some non-limiting examples of operating the HVR circuit in the very-low-power mode are described herein. When the load current exceeds TA1, the HVR circuit can transition from the very-low-power mode 690 to the low-power mode 680.

When the load current is between TA1 and TA2, the HVR circuit can operate in the low-power mode 680. Some non-limiting examples of operating the HVR circuit in the low-power mode are described herein. When the load current drops below TA1, the HVR circuit can transition from the low-power mode 680 to the very-low-power mode 690. Alternatively, when the load current exceeds TA2, the HVR circuit can transition from the low-power mode 680 to the moderate-power mode 670.

When the load current is between TA2 and TA3, the HVR circuit can operate in the moderate-power mode 670. Some non-limiting examples of operating the HVR circuit in the moderate-power mode are described herein. When the load current drops below TA2, the HVR circuit can transition from the moderate-power mode 670 to the low-power mode 680. Alternatively, when the load current exceeds TA3, the HVR circuit can transition from the moderate-power mode 670 to the full-power mode 660.

When the load current is above TA3, the HVR circuit can operate in the full-power mode 660. Some non-limiting examples of operating the HVR circuit in the full-power mode are described herein. When the load current drops below TA3, the HVR circuit can transition from the full-power mode 660 to the moderate-power mode 670.

In some examples, when the HVR circuit is in very-low-power mode 690 or the low-power mode 680, and the load current suddenly spikes above TA3, the HVR circuit can transition directly to the full-power mode 660.

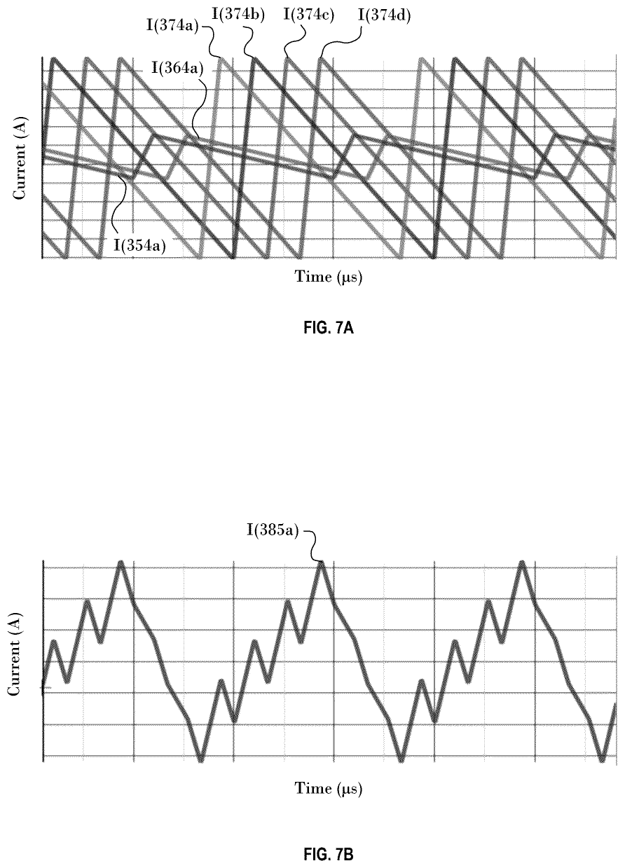

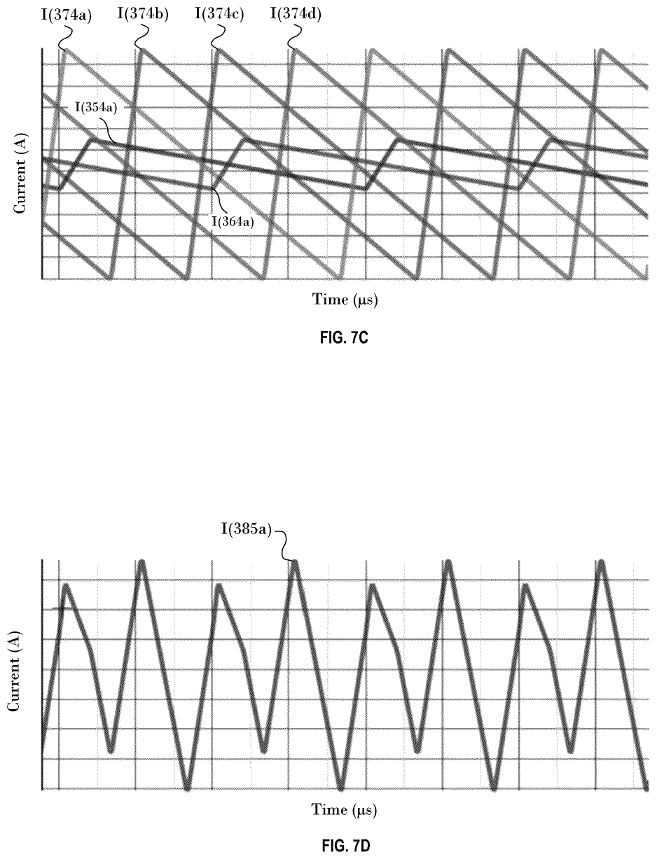

FIG. 7A illustrates one example of phase currents of an exemplary configuration of a multiphase, hybrid voltage regulator circuit 330a. In the example of FIG. 7A, the HVR circuit 330a is configured with 6 power stages (a hybrid phase circuit 350a, a nonlinear phase circuit 360a, and four linear phase circuits 370a-d) producing current pulses through their respective inductors (354a, 364a, and 374a-d) in 6 phases. In FIG. 7A, the currents produced by the 6 phase circuits are represented by the notation I(354a) (the current produced by the hybrid phase circuit 350a), I(364a) (the current produced by the nonlinear phase circuit 360a), and I(374a-d) (the currents produced by the linear phase circuits 370a-d). In the example of FIG. 7A, the phase separation between adjacent pulses is 6/360=60 degrees, the amplitudes of the currents range from 6 to 28 A, and the duration of the timing diagram is 6 μs.

FIG. 7B illustrates an example of a load current of the hybrid voltage regulator circuit 330a, when configured to produce the phase currents of FIG. 7A. As FIG. 7B shows, the amplitude of the load current varies between 84 A and 116 A, yielding a current ripple of 32 A over the 6 μs duration of the timing diagram. This example illustrates how uniformly interleaving low-amplitude phase currents (e.g., the phase currents produced by the hybrid phase circuit and the nonlinear phase circuit in FIG. 7A) with high-amplitude phase currents (e.g., the phase currents produced by the linear phase circuits in FIG. 7A) can introduce significant ripple into the load current.

FIG. 7C illustrates another example of phase currents of an exemplary configuration of a multiphase, hybrid voltage regulator circuit 330a. In the example of FIG. 7C, the HVR circuit 330a is configured with 6 power stages (a hybrid phase circuit 350a, a nonlinear phase circuit 360a, and four linear phase circuits 370a-d) producing current pulses through their respective inductors (354a, 364a, and 374a-d) in 6 phases. In FIG. 7C, the currents produced by the 6 phase circuits are represented by the notation I(354a) (the current produced by the hybrid phase circuit 350a), I(364a) (the current produced by the nonlinear phase circuit 360a), and I(374a-d) (the currents produced by the linear phase circuits 370a-d). In the example of FIG. 7C, the phase separation between the low-amplitude current pulses produced by the hybrid and nonlinear phase circuits is 2/360=180 degrees, and the phase separation between the high-amplitude current pulses produced by the linear phase circuits is 4/360=90 degrees. As in FIG. 7A, the amplitudes of the current pulses range from 6 to 28 A. The duration of the timing diagram is 3 μs.

FIG. 7D illustrates an example of a load current of the hybrid voltage regulator circuit 330a, when configured to produce the phase currents of FIG. 7C. As FIG. 7D shows, the amplitude of the load current varies between 92 A and 108 A, yielding a current ripple of 15.4 A over the 3 μs duration of the timing diagram. This example illustrates how uniformly interleaving low-amplitude phase currents (e.g., the phase currents produced by the hybrid phase circuit and the nonlinear phase circuit in FIG. 7C) with each other, and uniformly interleaving high-amplitude phase currents (e.g., the phase currents produced by the linear phase circuits in FIG. 7C) with each other can reduce ripple into the load current.

Techniques operating according to the principles described herein can be implemented in any suitable manner. While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above are flowcharts showing steps and acts of processes that regulate the voltage of a signal. The processing and decision blocks of the flowcharts above represent steps and acts that can be included in algorithms that carry out these processes. Algorithms derived from these processes (or steps thereof) can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein do not depict the syntax or operation of any particular circuit or of any particular programming language or type of programming language. Rather, the flowchart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application. In other implementations, the functional facilities can be adapted to interact with other functional facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory 126, accelerator memory 138, and/or storage 146 of the computer system 100 of FIG. 1 or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

Further, some techniques described above comprise acts of storing information (e.g., data and/or instructions) in certain ways for use by these techniques. In some implementations of these techniques-such as implementations where the techniques are implemented as computer-executable instructions-the information can be encoded on a computer-readable storage media. Where specific structures are described herein as advantageous formats in which to store this information, these structures can be used to impart a physical organization of the information when encoded on the storage medium. These advantageous structures can then provide functionality to the storage medium by affecting operations of one or more processors interacting with the information; for example, by increasing the efficiency of computer operations performed by the processor(s).

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within ±20%, ±10%, or ±5% of the second numeric value.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A computer system comprising:
one or more integrated circuits; and
a voltage regulator device including a hybrid phase circuit and a capacitive component,
wherein the hybrid phase circuit includes a heterogeneous power stage and a nonlinear inductive component coupled between the hybrid phase circuit and the capacitive component, and the heterogeneous power stage is configured to provide a signal to the nonlinear inductive component,
wherein the hybrid phase circuit is configured to selectively operate in a first mode, wherein an amplitude of a current of the signal is less than a first threshold amplitude and a first inductance of the nonlinear inductive component is greater than a first threshold inductance,
wherein the hybrid phase circuit is further configured to selectively operate in a second mode, wherein the amplitude of the current of the signal is greater than a second threshold amplitude, and a second inductance of the nonlinear inductive component is less than a second threshold inductance, and
wherein the voltage regulator device is configured to provide a power supply signal having a regulated voltage to the one or more integrated circuits.

2. The computer system of claim 1, further comprising a voltage regulator (VR) controller coupled to the voltage regulator device and configured to control an amplitude of the regulated voltage of the power supply signal provided by the voltage regulator device.

3. The computer system of claim 2, wherein the VR controller is further configured to control the hybrid phase circuit to operate in the first mode during a first time period based on the amplitude of the current of the signal being less than the first threshold amplitude during the first time period, and to control the hybrid phase circuit to operate in the second mode during a second time period based on the amplitude of the current of the signal being greater than the second threshold amplitude during the second time period.

4. The computer system of claim 3, wherein:
the VR controller controlling the hybrid phase circuit to operate in the first mode during the first time period comprises the VR controller providing a first plurality of control signals to heterogeneous power stage during the first time period, and
the VR controller controlling the hybrid phase circuit to operate in the second mode during the second time period comprises the VR controller providing a second plurality of control signals to the heterogeneous power stage during the second time period.

5. The computer system of claim 2, wherein the hybrid phase circuit is a first phase circuit, the heterogeneous power stage is a first power stage, the nonlinear inductive component is a first nonlinear inductive component, and the signal provided by the first phase circuit is a first signal, and the voltage regulator device further comprises:
one or more second phase circuits, each of the second phase circuits including a second nonlinear inductive component and a second power stage configured to provide a second signal to the second nonlinear inductive component, wherein the second nonlinear inductive component of each second phase circuit is coupled between the second power stage of the respective second phase circuit and the capacitive component;
one or more third phase circuits, each of the third phase circuits including a third inductive component and a third power stage configured to provide a third signal to the third inductive component, wherein the third inductive component of each third phase circuit is coupled between the third power stage of the respective third phase circuit and the capacitive component.

6. The computer system of claim 5, wherein the VR controller is further configured to perform operations including:
monitoring one or more parameters of the voltage regulator device; and
controlling an operating mode of the voltage regulator device based on whether the one or more monitored parameters satisfy one or more criteria.

7. The computer system of claim 6, wherein the one or more parameters of the voltage regulator device include an amplitude of a current of the power supply signal provided by the voltage regulator device to the one or more integrated circuits.

8. The computer system of claim 1, further comprising a printed circuit board, wherein the voltage regulator device and the one or more integrated circuits are attached to the printed circuit board, and wherein the voltage regulator device is electrically coupled to the one or more integrated circuits via the printed circuit board.

9. The computer system of claim 1, wherein the one or more integrated circuits include a central processing unit (CPU), a graphics processing unit (GPU), and/or an accelerated processing unit (APU).

10. A voltage regulator device comprising:
a hybrid phase circuit including a heterogeneous power stage and a nonlinear inductive component; and
a capacitive component,
wherein a first terminal of the nonlinear inductive component is coupled to an output terminal of the heterogeneous power stage, a second terminal of the nonlinear inductive component is coupled to a terminal of the capacitive component, and the heterogeneous power stage is configured to provide a signal to the nonlinear inductive component,
wherein the hybrid phase circuit is configured to selectively operate in a first mode, wherein an amplitude of a current of the signal is less than a first threshold amplitude and a first inductance of the nonlinear inductive component is greater than a first threshold inductance, and
wherein the hybrid phase circuit is further configured to selectively operate in a second mode, wherein the amplitude of the current of the signal is greater than a second threshold amplitude, and a second inductance of the nonlinear inductive component is less than a second threshold inductance.

11. The voltage regulator device of claim 10, wherein the hybrid phase circuit and the capacitive component form a DC-to-DC converter.

12. The voltage regulator device of claim 10, wherein the heterogeneous power stage comprises switch control and driver circuitry and a plurality of half bridges.

13. The voltage regulator device of claim 12, wherein:
in the first mode, a first number N1 of the half bridges are configured to provide the signal to the nonlinear inductive device,
in the second mode, a second number N2 of the half bridges are configured to provide the signal to the nonlinear inductive device, and
1≤N1<N2.

14. The voltage regulator device of claim 12, wherein:
in the first mode, a first set S1 of the half bridges are configured to provide the signal to the nonlinear inductive device,
in the second mode, a second set S2 of the half bridges are configured to provide the signal to the nonlinear inductive device, and
the first and second sets are disjoint.

15. The voltage regulator device of claim 12, wherein:
in the first mode, when one or more first switches of the heterogeneous power stage operate with a first duty cycle, the amplitude of the current of the signal has a first value, and
in the second mode, when one or more second switches of the heterogeneous power stage operate with the first duty cycle, the amplitude of the current of the signal has a second value greater than the first value.

16. The voltage regulator device of claim 10, wherein the hybrid phase circuit is a first phase circuit, the heterogeneous power stage is a first power stage, and the nonlinear inductive component is a first nonlinear inductive component, the voltage regulator device further comprising:
one or more second phase circuits, each of the second phase circuits including a second power stage and a second nonlinear inductive component coupled between the respective second power stage and the capacitive component.

17. The voltage regulator device of claim 16, further comprising:
one or more third phase circuits, each of the third phase circuits including a third power stage and a third inductive component coupled between the respective third power stage and the capacitive component.

18. A method comprising:
producing, by a heterogeneous power stage of a voltage regulator device, a signal; and
providing the signal to a nonlinear inductive component coupled between the heterogeneous power stage and a capacitive component of the voltage regulator device,
wherein producing the signal includes
during a first time period, operating the heterogeneous power stage in a first mode, wherein an amplitude of a current of the signal is less than a first threshold amplitude and a first inductance of the nonlinear inductive component is greater than a first threshold inductance, and
during a second time period, operating the heterogeneous power stage in a second mode, wherein the amplitude of the current of the signal is greater than a second threshold amplitude, and a second inductance of the nonlinear inductive component is less than a second threshold inductance.

19. The method of claim 18, wherein:
the heterogeneous power stage comprises a plurality of half bridges,
operating the heterogeneous power stage in the first mode comprises activating at least one and at most N1 of the half bridges and deactivating one or more of the half bridges,
operating the heterogeneous power stage in the second mode comprises activating at least N2 of the half bridges, and
1≤N1<N2.

20. The method of claim 18, wherein:
the heterogeneous power stage comprises a plurality of half bridges,
operating the heterogeneous power stage in the first mode comprises activating a first non-empty set of the half bridges and deactivating a second non-empty set of the half bridges, and
operating the heterogeneous power stage in the second mode comprises deactivating the first non-empty set of the half bridges and activating the second non-empty set of the half bridges.
